(19) United States
(12) Patent Application Publication
(10) Pub. No.: US 2023/0365841 A1
(43) Pub. Date: Nov. 16, 2023

(54) CROSSLINKABLE AND CROSSLINKED COMPOSITIONS

(71) Applicant: 3M INNOVATIVE PROPERTIES COMPANY, St. Paul, MN (US)

(72) Inventors: Peter M. Simone, Woodbury, MN (US); Jason D. Clapper, Lino Lakes, MN (US); Mark F. Ellis, St. Paul, MN (US); Hollis Z. Beagi, Stillwater, MN (US); Matthew H. Wessel, St. Paul, MN (US)

(21) Appl. No.: 18/247,988

(22) PCT Filed: Oct. 11, 2021
(86) PCT No.: PCT/IB2021/059299

§ 371 Date: Apr. 5, 2023

Related U.S. Application Data
(60) Provisional application No. 63/198,673, filed on Nov. 3, 2020.

(51) Int. Cl. C09J 7/38; C09J 7/35

(52) U.S. Cl. CPC C09J 7/385; C09J 7/35; C09J 2203/326; C09J 2301/302; C09J 2301/304; C09J 2301/416; C09J 2301/414; C09J 2451/00

(57) ABSTRACT

A crosslinkable composition, a crosslinked composition formed upon exposure of the crosslinkable composition to ultraviolet radiation or ionizing radiation, articles containing these crosslinkable or crosslinked compositions, and methods of making the articles are described. The crosslinkable compositions contain two different (meth)acrylate polymers and can be applied to a substrate using an extrusion process. While being extruded, the crosslinkable compositions advantageously are resistant to crosslinking and/or significantly increasing in molecular weight. The crosslinked compositions can function as either a pressure-sensitive adhesive composition or a heat bondable adhesive composition and are particularly well suited for use in electronic devices.

### TECHNICAL FIELD

A crosslinkable composition, a crosslinked composition formed upon exposure of the crosslinkable composition to ultraviolet radiation or ionizing radiation, articles containing these crosslinkable or crosslinked compositions, and methods of making the articles are described.

### BACKGROUND

Adhesive tapes are virtually ubiquitous in the home and workplace. In one of its simplest configurations, the adhesive tape includes a backing layer and an adhesive layer attached to the backing layer. The adhesives are often either a pressure-sensitive adhesive that is tacky at room temperature or a heat bondable adhesive that is not tacky at room temperature but that can adhere to a surface when heated.

Both pressure-sensitive adhesives and heat bondable adhesives have been used in bonding various components of electronic displays. To enable good performance of the electronic displays, the selected adhesive needs to have suitable optical, mechanical, and electrical properties that remain relatively stable during the lifetime of the electronic display.

### SUMMARY

A crosslinkable composition, a crosslinked composition formed upon exposure of the crosslinkable composition to ultraviolet radiation or ionizing radiation, articles containing the crosslinkable or crosslinked composition, and methods of making the articles are described. The crosslinkable compositions contain two different (meth)acrylate polymers and can be applied to a substrate using an extrusion process. While being extruded, the crosslinkable compositions advantageously are resistant to crosslinking and/or significantly increasing in molecular weight. The crosslinked compositions can function as either a pressure-sensitive adhesive composition or a heat bondable adhesive composition and are particularly well suited for use in electronic devices.

In a first aspect, a crosslinkable composition is provided. The crosslinkable composition contains 50 to 95 weight percent of a first (meth)acrylate polymer and 5 to 50 weight percent of a second (meth)acrylate polymer based on a total weight of polymeric material in the crosslinkable compositions. The first (meth)acrylate polymer has a weight average molecular weight (Mw) in a range of 100,000 Daltons to 1,500,000 Daltons and comprises 1) a monomeric unit derived from an alkyl (meth)acrylate, 2) an optional monomeric unit derived from a hydroxy-containing monomer in an amount ranging from 0 to 10 weight percent based on a total weight of monomeric units in the first (meth)acrylate polymer, and 3) an optional crosslinking monomeric unit having either a pendant (meth)acryloyl group or a pendant aromatic ketone group. The second (meth)acrylate polymer has a weight average molecular weight ranging from 5,000 Daltons to less than 100,000 Daltons and comprises 1) a monomeric unit derived from an alkyl (meth)acrylate, 2) a monomeric unit derived from a hydroxy-containing monomer in an amount ranging from 15 to 70 weight percent based on a total weight of monomeric units in the second (meth)acrylate polymer, and 3) a crosslinking monomeric unit having a pendant (meth)acryloyl group.

In a second aspect, a crosslinked composition is provided that is a reaction product of a crosslinkable composition after exposure to ultraviolet radiation or ionizing radiation. The crosslinkable composition is the same as described above in the first aspect.

In a third aspect, an article is provided that contains a substrate and a layer of the crosslinkable composition positioned adjacent to the substrate. The crosslinkable composition is the same as described above in the first aspect.

In a fourth aspect, an article is provided that contains a substrate and a layer of the crosslinked composition positioned adjacent to the substrate. The crosslinked composition is the same as described above in the second aspect.

In a fifth aspect, a method of making an article is provided. The method includes providing a substrate, positioning a layer of a crosslinkable composition adjacent to the substrate, and exposing the layer of the crosslinkable composition to ultraviolet radiation or ionizing radiation to form a layer of a crosslinked composition. The crosslinkable composition is the same as described in the first aspect.

### DETAILED DESCRIPTION

Crosslinkable compositions, crosslinked compositions, articles containing these crosslinkable or crosslinked compositions, and methods of making the articles are provided. The crosslinkable compositions, which include two different (meth)acrylate polymers, are used to form the crosslinked compositions upon exposure to ultraviolet radiation or to ionizing radiation. The crosslinkable compositions are well suited for use with hot melt processing methods. The crosslinked compositions can function as a pressure-sensitive adhesive or as a heat bondable adhesive and are well suited for use in electronic devices.

The use of (meth)acrylate polymers having pendant hydroxy groups are advantageous in adhesive compositions used for electronic devices to provide hydrophilicity to the adhesive composition. The hydrophilicity can be controlled to minimize phase separation of absorbed water within the adhesive composition when an electronic display device is subjected to fluctuations in ambient temperature and humidity. Phase separation tends to lead to increased haziness, which is undesirable for applications where clarity of the adhesive composition is important. Additionally, the hydroxy groups can increase the dielectric constant of the adhesive composition. The increased dielectric constant can enhance the touch sensitivity of electronic devices.

Many known pressure-sensitive or heat bondable adhesive compositions contain a single type of (meth)acrylate polymer as the main (base) component of the composition. Some of these (meth)acrylate polymers have been prepared using hydroxy-containing monomers. When the amount of the hydroxy-containing monomer is increased sufficiently to advantageously impact the hydrophilicity of the (meth)acrylate polymer and/or to enhance the dielectric constant of the (meth)acrylate polymer, the viscosity of the crosslinkable composition may increase to an unacceptable level or the material may begin to gel when subjected to high temperature processing such as hot melt extrusion. The gel may be due, at least in part, to transesterification reactions within the (meth)acylate polymer. Surprisingly, the addition of hydroxy-containing monomeric units to a low molecular weight (meth)acrylate polymer (i.e., second (meth)acrylate polymer) that is blended with a base (meth)acrylate polymer (i.e., first (meth)acrylate polymer) can advantageously address the viscosity issues of the crosslinkable composition when subjected to high temperature processing. The base (meth)acrylate polymer can be made without hydroxy-containing monomers or with an amount that does not adversely increase its viscosity under extrusion conditions.

The crosslinkable composition contains 50 to 95 weight percent of a first (meth)acrylate polymer and 5 to 50 weight percent of a second (meth)acrylate polymer based on a total weight of polymeric material in the crosslinkable compositions. The first (meth)acrylate polymer, which is the base (meth)acrylate polymer, has a weight average molecular weight (Mw) in a range of 100,000 Daltons to 1,500,000 Daltons and comprises 1) a monomeric unit derived from an alkyl (meth)acrylate, 2) an optional monomeric unit derived from a hydroxy-containing monomer in an amount ranging from 0 to 10 weight percent based on a total weight of monomeric units in the first (meth)acrylate polymer, and 3) an optional crosslinking monomeric unit having a pendant (meth)acryloyl group or having a pendant aromatic ketone group. The second (meth)acrylate polymer has a weight average molecular weight ranging from 5,000 Daltons to less than 100,000 Daltons and comprises 1) a monomeric unit derived from an alkyl (meth)acrylate, 2) a monomeric unit derived from a hydroxy-containing monomer in an amount ranging from 15 to 70 weight percent based on a total weight of monomeric units in the second (meth)acrylate polymer, and 3) a crosslinking monomeric unit having a pendant (meth)acryloyl group.

As used herein, the term “(meth)acrylate” refers to either a methacrylate or acrylate. In many embodiments, the (meth)acrylate is an acrylate. Similarly, the term “(meth)acrylic acid” refers to methacrylic acid or acrylic acid and the term “(meth)acrylamide” refers to acrylamide or methacrylamide. All these monomers have a (meth)acryloyl group of formula CH₂═CR—(CO)— where R is hydrogen or methyl.

The term “(meth)acrylate polymer” refers to a polymer with at least 50 weight percent of the monomeric units being derived from monomers having a (meth)acryloyl group. The amount of such monomeric units can be, at least 60 weight percent, at least 70 weight percent, at least 80 weight percent, at least 90 weight percent, at least 95 weight percent, at least 97 weight percent, or at least 99 weight percent and up to 100 weight percent.

The term “monomer” refers to a group having a free radically polymerizable group, which is typically a (meth)acryloyl group or a vinyl group. The term “monomeric unit” refers to the polymerized version of the monomer within the polymeric material. A monomeric unit in the polymeric material is often derived from the corresponding monomer in a reaction mixture used to form the polymeric material. In some embodiments, a monomer in the reaction mixture can form a first monomeric unit in the polymeric material that is subsequently further reacted to form a second monomeric unit different than the first monomeric unit.

As used herein, the term “polymeric material” and “polymer” are used interchangeably to refer to a homopolymer, copolymer, terpolymer, and the like, or a mixture thereof. Tackifiers, which have a comparatively low molecular weight compared to the (meth)acrylate polymers disclosed herein, usually are not considered to be a polymer in this context.

The term “pressure-sensitive adhesive”, as defined by the Pressure-Sensitive Tape Council, has the following properties: (1) aggressive and permanent tack, (2) adherence with no more than finger pressure, (3) adequate ability to hold onto an adherend, and (4) adequate cohesive strength to be removed cleanly from the adherend. Based on the Dahlquist criterion, pressure-sensitive adhesives are those that have an elastic modulus of less than 1×10⁶ dynes/cm² at room temperature or below. That is, pressure-sensitive adhesives are tacky to room temperature or below.

The term “heat bondable adhesive” refers to an adhesive composition that requires heating above its glass transition temperature (typically above room temperature) and/or to a temperature at which the modulus of the adhesive satisfies the Dahlquist criterion (e.g., to be tacky).

The term “and/or” such as in the expression A and/or B means either A alone or B alone or both A and B.

The terms “in a range of” or “in the range of” and other phrases used to define a range are used interchangeably to refer to all values within the range plus the endpoints of the range.

### First (Meth)Acrylate Polymer

The first (meth)acrylate polymer in the crosslinkable composition forms an elastomeric material upon crosslinking in the presence of the second (meth)acrylate polymer. The first (meth)acrylate polymer has a weight average molecular weight (Mw) in a range of 100,000 Daltons to 1,500,000 Daltons and comprises 1) a monomeric unit derived from an alkyl (meth)acrylate, 2) an optional monomeric unit derived from a hydroxy-containing monomer in an amount ranging from 0 to 10 weight percent based on a total weight of monomeric units in the first (meth)acrylate polymer, and 3) an optional crosslinking monomeric unit having either a pendant (meth)acryloyl group or a pendant aromatic ketone group.

The first (meth)acrylate polymer contains monomeric units derived from at least one alkyl (meth)acrylate monomer. The alkyl group can be linear (e.g., with 1 to 32 carbon atoms, 1 to 20 carbon atoms, 1 to 10 carbon atoms, 1 to 6 carbon atoms, or 1 to 4 carbon atoms), branched (e.g., with 3 to 32 carbon atoms, 3 to 20 carbon atoms, or 3 to 10 carbon atoms), cyclic (e.g., with 3 to 32 carbon atoms, 3 to 20 carbon atoms, or 3 to 10 carbon atoms), or a combination thereof. Often, the first (meth)acrylate polymer contains more than one type of monomeric unit derived from alkyl (meth)acrylate monomers. For example, different alkyl (meth)acrylate monomers can be used to adjust the glass transition temperature of the first (meth)acrylate polymer.

Exemplary alkyl (meth)acrylates include, but are not limited to, methyl (meth)acrylate, ethyl (meth)acrylate, n-propyl (meth)acrylate, isopropyl (meth)acrylate, n-butyl (meth)acrylate, isobutyl (meth)acrylate, n-pentyl (meth)acrylate, 2-methylbutyl (meth)acrylate, n-hexyl (meth)acrylate, cyclohexyl (meth)acrylate, isobornyl (meth)acrylate, 4-methyl-2-pentyl (meth)acrylate, 2-ethylhexyl (meth)acrylate, 2-methylhexyl (meth)acrylate, n-octyl (meth)acrylate, isooctyl (meth)acrylate, 2-octyl (meth)acrylate, isononyl (meth)acrylate, isoamyl (meth)acrylate, n-decyl (meth)acrylate, isodecyl (meth)acrylate, 2-propylheptyl (meth)acrylate, isotridecyl (meth)acrylate, isostearyl (meth)acrylate, octadecyl (meth)acrylate, 2-octyldecyl (meth)acrylate, dodecyl (meth)acrylate, lauryl (meth)acrylate, and heptadecanyl (meth)acrylate. Some exemplary branched alkyl (meth)acrylates are (meth)acrylic acid esters of Guerbet alcohols having 12 to 32 carbon atoms as described in U.S. Pat. No. 8,137,807 B2 (Clapper et al.). Various isomer mixtures of the alkyl (meth)acrylates can be used such as those described, for example, in U.S. Pat. No. 9,102,774 B2 (Clapper et al.).

The monomeric units derived from the alkyl (meth)acrylate are often at least 65 weight percent of the total weight of monomeric units in the first (meth)acrylate monomer. For example, the first (meth)acrylate polymer can contain at least 70 weight percent, at least 75 weight percent, at least 80 weight percent, at least 85 weight percent, at least 90 weight percent, or at least 95 and up to 100 weight percent, up to 95 weight percent, up to 90 weight percent, up to 85 weight percent, up to 80 weight percent, or up to 75 weight percent monomeric units derived from an alkyl (meth)acrylate.

The first (meth)acrylate polymer may optionally include monomeric units derived from hydroxy-containing monomers. Exemplary hydroxy-containing monomers include, but are not limited to, hydroxyalkyl (meth)acrylates (e.g., 2-hydroxyethyl (meth)acrylate, 2-hydroxypropyl (meth)acrylate, 3-hydroxypropyl (meth)acrylate, and 4-hydroxybutyl (meth)acrylate), hydroxyalkyl (meth)acrylamides (e.g., 2-hydroxyethyl (meth)acrylamide or 3-hydroxypropyl (meth)acrylamide), ethoxylated hydroxyethyl (meth)acrylate, and aryloxy substituted hydroxyalkyl (meth)acrylates (e.g., 2-hydroxy-2-phenoxypropyl (meth)acrylate).

The first (meth)acrylate polymer can optionally contain 0 to 10 weight percent monomeric units derived from a hydroxy-containing monomer based on a total weight of monomeric units in the first (meth)acrylate polymer. These monomeric units can be referred to as hydroxy-containing monomeric units. If more than 10 weight percent hydroxy-containing monomeric units are included in the first (meth)acrylate polymer, the effect of transesterification reactions can become more problematic at elevated temperatures (e.g., about 120° C. or above) resulting in viscosity increases. The amount of the hydroxy-containing monomeric units can be up to 10 weight percent, up to 8 weight percent, up to 6 weight percent, up to 5 weight percent, up to 4 weight percent, up to 3 weight percent, up to 2 weight percent, or up to 1 weight percent. If present, the amount can be at least 0.1 weight percent, at least 0.2 weight percent, at least 0.5 weight percent, at least 1 weight percent, or at least 2 weight percent. The amount can be, for example, in a range of 0 to 10 weight percent, in a range of 1 to 10 weight percent, 0 to 5 weight percent, 1 to 5 weight percent, or 0 to 3 weight percent based on the total weight of monomeric units in the first (meth)acrylate polymer. In some embodiments, the first (meth)acrylate polymer is free or substantially free (e.g., less than 0.1 weight percent, less than 0.05 weight percent, or less than 0.01 weight percent) of hydroxy-containing monomers.

The first (meth)acrylate polymer may optionally include polar monomeric units other than those derived from hydroxy-containing monomers. That is, the first (meth)acrylate polymer can contain non-hydroxy-containing polar monomeric units. Such monomeric units can have an acidic group, a primary amido group, a secondary amido group, a tertiary amido group, an amino group, or an ether group (i.e., a group containing at least one alkylene-oxy-alkylene group of formula —R—O—R— where each R is an alkylene having 1 to 4 carbon atoms). The polar group can be a neutral species or in the form of a salt. For example, the acidic group can be in the form of an anion and can have a cationic counter ion. In many embodiments, the cationic counter ion is an alkaline metal ion (e.g., sodium, potassium, or lithium ion), an alkaline earth ion (e.g., calcium, magnesium, or strontium ion), an ammonium ion, or an ammonium ion substituted with one or more alkyl or aryl groups. The various amido or amino groups can be in the form of a cation and can have an anionic counter ion. In many embodiments, the anionic counter ion is a halide, acetate, formate, sulfate, phosphate, or the like.

Exemplary non-hydroxy-containing polar monomeric units with an acidic group can be derived from acidic monomers such as, for example, a carboxylic acid monomer, a phosphonic acid monomer, a sulfonic acid monomer, a salt thereof, or a combination thereof. Exemplary acidic monomers include, but are not limited to, (meth)acrylic acid, itaconic acid, fumaric acid, crotonic acid, citraconic acid, maleic acid, oleic acid, B-carboxyethyl acrylate, 2-(meth)acrylamidoethanesulfonic acid, 2-(meth)acrylamido-2-methylpropane sulfonic acid, vinylsulfonic acid, and the like. If present, the polar monomer having an acidic group is often (meth)acrylic acid.

For pressure-sensitive adhesives for use in electronic devices, the monomeric unit having an acidic group is often absent or present in a minimal amount so that its presence does not result in the corrosion or dissolution of metal-containing components that are included in such devices. In some embodiments, the first (meth)acrylate polymer is free or substantially free (e.g., less than 0.5 weight percent, less than 0.1 weight percent, less than 0.05 weight percent, or less than 0.01 weight percent based on a total weight of monomeric units within the first (meth)acrylate polymer) of monomeric units having an acidic group.

Exemplary non-hydroxy-containing polar monomeric units with a primary amido group include those derived from (meth)acrylamide. Exemplary non-hydroxy-containing polar monomeric units with secondary amido groups include, but are not limited to, those derived from N-alkyl (meth)acrylamides such as N-methyl (meth)acrylamide, N-ethyl (meth)acrylamide, N-isopropyl (meth)acrylamide, N-tert-octyl (meth)acrylamide, or N-octyl (meth)acrylamide. Exemplary polar monomeric units with a tertiary amido group include, but are not limited to, those derived from N-vinyl caprolactam, N-vinyl-2-pyrrolidone, (meth)acryloyl morpholine, and N,N-dialkyl (meth)acrylamides such as N,N-dimethyl (meth)acrylamide, N,N-diethyl (meth)acrylamide, N,N-dipropyl (meth)acrylamide, and N,N-dibutyl (meth)acrylamide.

Non-hydroxy-containing polar monomeric units with an amino group include those derived from various N,N-dialkylaminoalkyl (meth)acrylates and N,N-dialkylaminoalkyl (meth)acrylamides. Examples include, but are not limited to, N,N-dimethyl aminoethyl (meth)acrylate, N,N-dimethylaminoethyl (meth)acrylamide, N,N-dimethylaminopropyl (meth)acrylate, N,N-dimethylaminopropyl (meth)acrylamide, N,N-diethylaminoethyl (meth)acrylate, N,N-diethylaminoethyl (meth)acrylamide, N,N-diethylaminopropyl (meth)acrylate, and N,N-diethylaminopropyl (meth)acrylamide.

Exemplary non-hydroxy-containing polar monomeric units with an ether group include, but are not limited to, those derived from alkoxylated alkyl (meth)acrylates such as ethoxyethoxyethyl (meth)acrylate, 2-methoxyethyl (meth)acrylate, and 2-ethoxyethyl (meth)acrylate; and poly(alkylene oxide) (meth)acrylates such as poly(ethylene oxide) (meth)acrylates and poly(propylene oxide) (meth)acrylates. The poly(alkylene oxide) acrylates are often referred to as poly(alkylene glycol) (meth)acrylates. These monomers typically have terminal alkoxy group. For example, when the end group is a methoxy group, the monomer can be referred to as methoxy poly(ethylene glycol) (meth)acrylate.

In many embodiments, the first (meth)acrylate polymer includes a non-hydroxy-containing polar monomeric unit having a basic group. These monomeric units are often derived from nitrogen-containing monomers such as those with a primary amido group, secondary amido group, or amino group.

The optional non-hydroxy-containing polar monomeric units can be included in an amount up to 30 weight percent (i.e., 0 to 30 weight percent) based on total weight of monomeric units in the first (meth)acrylate polymer. In many embodiments, this monomeric unit is present in an amount up to 30 weight percent, up to 25 weight percent, up to 20 weight percent, up to 15 weight percent, up to 10 weight percent, or up to 5 weight percent based on total weight of monomeric units in the first (meth)acrylate polymer. If present, the first (meth)acrylate polymer often contains at least 0.1 weight percent, at least 0.5 weight percent, at least 1 weight percent, at least 2 weight percent, at least 3 weight percent, or at least 5 weight percent non-hydroxy-containing polar monomeric units. This monomeric unit can be present, for example, in an amount in the range of 0.1 to 30 weight percent, 0.5 to 30 weight percent, 1 to 30 weight percent, 0 to 25 weight percent, 1 to 25 weight percent, 0 to 20 weight percent, 1 to 20 weight percent, 0 to 15 weight percent, 1 to weight percent, 0 to 10 weight percent, 1 to 10 weight percent, or 1 to 5 weight percent based on the total weight of monomer in the first (meth)acrylate polymer.

Any other optional monomeric units can be included in the first (meth)acrylate polymer if the monomers from which they are derived are compatible with (e.g., miscible with) the monomers in the first reaction mixture used to form the first (meth)acrylate polymer or a first precursor polymer thereof. Examples of other monomers include various aryl (meth)acrylate (e.g., phenyl (meth)acrylate), vinyl ethers, vinyl esters (e.g., vinyl acetate), olefinic monomers (e.g., ethylene propylene, or butylene), styrene, styrene derivatives (e.g., alpha-methyl styrene), and the like. Still other example monomers are aryl substituted alkyl (meth)acrylates or alkoxy substituted alkyl (meth)acrylates such as 2-biphenylhexyl (meth)acrylate, benzyl (meth)acrylate, and 2-phenoxy ethyl (meth)acrylate. In many embodiments the (meth)acrylate is an acrylate. The first reaction mixture typically does not include a monomer with multiple (meth)acryloyl groups or multiple vinyl groups.

The first (meth)acrylate polymer can optionally include a crosslinking monomeric unit that can be crosslinked when exposed to ultraviolet or ionizing radiation. The crosslinking monomeric units have either 1) a pendant aromatic ketone group or 2) a pendant (meth)acryloyl group. The optional crosslinking monomeric units can be used to crosslink the first (meth)acrylate polymer to itself or to crosslink the first (meth)acrylate polymer to the second (meth)acrylate polymer

The first type of crosslinking monomeric units having a pendant aromatic ketone group are derived from a UV crosslinking monomer having such a group. The UV crosslinking monomer is combined with all the other monomers in a first reaction mixture used to form the first (meth)acrylate polymer. The UV crosslinking monomer is typically a benzophenone-based monomer. Examples of benzophenone-based monomers that can function as UV crosslinking monomers include, but are not limited to, 4-(meth)acryloyloxybenzophenone, 4-(meth)acryloyloxyethoxybenzophenone, 4-(meth)acryloyloxy-4′-methoxybenzophenone, 4-(meth)acryloyloxyethoxy-4′-methoxybenzophenone, 4-(meth)acryloyloxy-4′-bromobenzophenone, 4-acryloyloxyethoxy-4′-bromobenzophenone, and the like. When exposed to UV radiation, the aromatic ketone group, which is often a benzophenone-containing group, can abstract a hydrogen atom from another polymeric chain or another portion of the same polymeric chain. This abstraction results in the formation of crosslinks between polymeric chains or within the same polymeric chain.

The second type of crosslinking monomeric units having a pendant (meth)acryloyl group pendant usually are not introduced directly into the first (meth)acrylate polymer but are the product of a reaction between a group on a first precursor polymer and an unsaturated reagent compound that can introduce the (meth)acryloyl group. Typically, the introduction of the pendant (meth)acryloyl group involves (1) the reaction between a nucleophilic group on the first precursor (meth)acrylate polymer and an electrophilic group on the unsaturated reagent compound (i.e., the unsaturated reagent compound includes both an electrophilic group and a (meth)acryloyl group) or (2) the reaction between electrophilic groups on the first precursor (meth)acrylate polymer and a nucleophilic group on the unsaturated reagent compound (i.e., the unsaturated reagent compound includes both a nucleophilic group and a (meth)acryloyl group). These reactions between the nucleophilic group and electrophilic group typically are ring opening, addition, or condensation reactions.

In some embodiments, the first precursor (meth)acrylate polymer has hydroxy, carboxylic acid (—COOH), amine (—NH₂), or anhydride (—O—(CO)—O—) groups. If the first precursor (meth)acrylate polymer has hydroxy groups or amine groups, the unsaturated reagent compound often has a carboxylic acid (—COOH), isocyanato (—NCO), epoxy (i.e., oxiranyl), or anhydride group in addition to a (meth)acryloyl group. If the first precursor (meth)acrylate polymer has carboxylic acid groups, the unsaturated reagent compound often has a hydroxy, amino, epoxy, isocyanato, aziridinyl, azetidinyl, or oxazolinyl group in addition to a (meth)acryloyl group.

In some specific examples, the first precursor (meth)acrylate polymer has hydroxy groups or amino groups and the unsaturated reagent compound has an isocyanato group and a (meth)acryloyl group. Such unsaturated reagent compounds include, but are not limited to, isocyanatoalkyl (meth)acrylate such as isocyanatoethyl (meth)acrylate. The use of a first precursor (meth)acrylate polymer having amine groups or hydroxy groups may be preferable in applications where the adhesive is used in articles having metal-containing components. Amino groups and hydroxy groups are less problematic in terms of corrosion than acidic groups or anhydride groups.

For the embodiment where the first precursor (meth)acrylate polymer has hydroxyl groups, the monomeric unit having the hydroxyl group has a pendant group —(CO)—O—R²—OH attached to the carbon backbone. If this group is reacted with an isocyanatoalkyl (meth)acrylate of formula H₂C═CHR¹—(CO)—O—R³—NCO as the unsaturated reagent compound. The reaction provides the first (meth)acrylate polymer having pendant groups of formula —(CO)—O—R²—O—(CO)—NH—R³—O—(CO)—CHR¹═CH₂. Groups R² and R³ are each independently an alkylene group such as an alkylene having 1 to 10 carbon atoms, 1 to 6 carbon atoms, or 1 to 4 carbon atoms. R¹ is methyl or hydrogen.

The crosslinking monomeric unit having either a pendant aromatic ketone group or a pendant (meth)acryloyl group is often present in the first (meth)acrylate polymer in an amount up to 5 weight percent (i.e., 0 to 5 weight percent) based on total weight of monomeric units in the first (meth)acrylate polymer. In some examples, the crosslinking monomeric units can be up to 5 weight percent, up to 4 weight percent, up to 3 weight percent, up to 2 weight percent, or up to 1 weight percent and at least 0.1 weight percent, at least 0.2 weight percent, at least 0.5 weight percent, or at least 1 weight percent.

The amount of the monomeric units having an aromatic ketone group is often limited when the polymerization reaction used to form the first (meth)acrylate polymer is initiated by exposure to UV radiation. That is, the UV crosslinkable monomer can cause undesirable gelation during the polymerization process. When polymerized using a photoinitiator, the first (meth)acrylate polymer may be free or substantially free (e.g., less than 0.1 weight percent, less than 0.05 weight percent, or less than 0.01 weight percent) of the UV crosslinking monomeric units based on total weight of monomeric units in the first (meth)acrylate polymer.

Some first (meth)acrylate polymers contain 60 to 100 weight percent monomeric units derived from alkyl (meth)acrylate, 0 to 10 weight percent monomeric units derived from a hydroxy-containing monomer, 0 to 30 weight percent monomeric units derived from non-hydroxy-containing polar monomers, and 0 to 5 or 0.1 to 5 weight percent crosslinking monomeric units having either a pendant (meth)acryloyl group or an aromatic ketone group. In other examples, the first (meth)acrylate polymer contains 70 to 99 weight percent monomeric units derived from alkyl (meth)acrylate, 0 to 10 weight percent monomeric units derived from a hydroxy-containing monomer, 1 to 30 weight percent monomeric units derived from a non-hydroxy-containing polar monomer, and 0 to 5 or 0.1 to 5 weight percent crosslinking monomeric units. In other examples, the first (meth)acrylate polymer contains 75 to 99 weight percent monomeric units derived from alkyl (meth)acrylate, 0 to 5 weight percent monomeric units derived from a hydroxy-containing monomer, 1 to 25 weight percent monomeric units derived from a non-hydroxy-containing polar monomer, and 0 to 5 or 0.1 to 5 weight percent crosslinking monomeric units. In other examples, the first (meth)acrylate polymer contains 80 to 99 weight percent monomeric units derived from alkyl (meth)acrylate, 0 to 5 weight percent monomeric units derived from a hydroxy-containing monomer, 1 to 20 weight percent monomeric units derived from a non-hydroxy-containing polar monomer, and 0 to 5 or 0.1 to 5 weight percent crosslinking monomeric units. In still other examples, the first (meth)acrylate polymer include 85 to 99 weight percent monomeric units derived from alkyl (meth)acrylate, 0 to 5 weight percent monomeric units derived from hydroxy-containing monomer, 1 to 15 weight percent monomeric units derived from non-hydroxy-containing polar monomers, and 0 to 5 or 0.1 to 5 weight percent crosslinking monomeric units. The amounts are based on total weight of monomeric units in the first (meth)acrylate polymer.

The first reaction mixture used to prepare the first (meth)acrylate polymer or the first precursor polymer (if the first (meth)acrylate polymer has a pendant (meth)acryloyl group) typically includes a free radical initiator to commence polymerization of the monomers. The free radical initiator can be a photoinitator or a thermal initiator.

In many embodiments, the free radical initiator is a thermal initiator. Suitable thermal initiators include various azo compound such as those commercially available under the trade designation VAZO from Chemours (Wilmington, DE, USA) including VAZO 67, which is 2,2′-azobis(2-methylbutane nitrile), VAZO 64, which is 2,2′-azobis(isobutyronitrile), VAZO 52, which is (2,2′-azobis(2,4-dimethylpentanenitrile), and VAZO 88, which is 1,1′-azobis(cyclohexane-carbonitrile); various peroxides such as benzoyl peroxide, cyclohexane peroxide, lauroyl peroxide, di-tert-amyl peroxide, tert-butyl peroxy benzoate, di-cumyl peroxide, and peroxides commercially available from Atofina Chemical, Inc. (Philadelphia, PA) under the trade designation LUPERSOL (e.g., LUPERSOL 101, which is 2,5-bis(tert-butylperoxy)-2,5-dimethylhexane, and LUPERSOL 130, which is 2,5-dimethyl-2,5-di-(tert-butylperoxy)-3-hexyne); various hydroperoxides such as tert-amyl hydroperoxide and tert-butyl hydroperoxide; and mixtures thereof.

In some embodiments, a photoinitiator can be used. Some exemplary photoinitiators are benzoin ethers (e.g., benzoin methyl ether or benzoin isopropyl ether) or substituted benzoin ethers (e.g., anisoin methyl ether). Other exemplary photoinitiators are substituted acetophenones such as 2,2-diethoxyacetophenone or 2,2-dimethoxy-2-phenylacetophenone (commercially available under the trade designation IRGACURE 651 from BASF Corp. (Florham Park, NJ, USA) or under the trade designation ESACURE KB-1 from Sartomer (Exton, PA, USA)). Still other exemplary photoinitiators are substituted alpha-ketols such as 2-methyl-2-hydroxypropiophenone, aromatic sulfonyl chlorides such as 2-naphthalenesulfonyl chloride, and photoactive oximes such as 1-phenyl-1,2-propanedione-2-(O-ethoxycarbonyl)oxime. Other suitable photoinitiators include, for example, 1-hydroxycyclohexyl phenyl ketone (commercially available under the trade designation IRGACURE 184), bis(2,4,6-trimethylbenzoyl)phenylphosphineoxide (commercially available under the trade designation IRGACURE 819), 1-[4-(2-hydroxyethoxy)phenyl]-2-hydroxy-2-methyl-1-propane-1-one (commercially available under the trade designation IRGACURE 2959), 2-benzyl-2-dimethylamino-1-(4-morpholinophenyl)butanone (commercially available under the trade designation IRGACURE 369), 2-methyl-1-[4-(methylthio)phenyl]-2-morpholinopropan-1-one (commercially available under the trade designation IRGACURE 907), and 2-hydroxy-2-methyl-1-phenyl propan-1-one (commercially available under the trade designation DAROCUR 1173 from Ciba Specialty Chemicals Corp. (Tarrytown, NY, USA).

The first reaction mixture may optionally further contain a chain transfer agent to control the molecular weight of the resultant precursor polymer or first (meth)acrylate polymer. Examples of useful chain transfer agents include, but are not limited to, carbon tetrabromide, alcohols (e.g., ethanol and isopropanol), mercaptans or thiols (e.g., lauryl mercaptan, butyl mercaptan, ethanethiol, isooctylthioglycolate, 2-ethylhexyl thioglycolate, 2-ethylhexyl mercaptopropionate, ethyleneglycol bisthioglycolate), and mixtures thereof. If used, the polymerizable mixture may include up to 1.0 weight percent of a chain transfer agent based on a total weight of monomers. For example, the first reaction mixture can contain 0.005 to 1.0 weight percent, 0.01 to 1.0 weight percent, 0.01 to 0.7 weight percent, 0.01 to 0.5 weight percent, 0.01 to 0.2 weight percent or 0.01 to 0.1 weight percent chain transfer agent.

The polymerization of the first reaction mixture can occur in the presence or absence of an organic solvent. If an organic solvent is included in the polymerizable mixture, the amount is often selected to provide the desired viscosity. Examples of suitable organic solvents include, but are not limited to, methanol, ethanol, isopropanol, n-propanol, n-butanol, tetrahydrofuran, hexane, cyclohexane, heptane, acetone, methyl ethyl ketone, methyl acetate, ethyl acetate, toluene, xylene, and ethylene glycol alkyl ether (e.g., ethylene glycol methyl ether). These organic solvents can be used alone or as mixtures.

In many embodiments, the polymerization reaction occurs with little or no organic solvent present. That is the first reaction mixture is free of organic solvent or contains a minimum amount of organic solvent. If desired, an organic solvent can be added to control the viscosity of the first reaction mixture and/or to effectively remove the first (meth)acrylate polymer from the reactor. If used, the organic solvent is often present in an amount up to 100 parts per hundred (100 pph) or more of the monomers although more can be used. The amount is often up to 100 pph, up to 80 pph, up to 60 pph, up to 40 pph, up to 10 pph, or up to 5 pph. If used, any organic solvent typically is removed at the completion of the polymerization reaction.

Although any known method of forming (meth)acrylate polymers can be used, in some embodiments it is desirable to minimize the use of organic solvents that will need to be removed later. One suitable method is to form the first (meth)acrylate polymer within a polymeric pouch that has been purged to remove oxygen. When prepared in this manner, a photoinitiator is often used. This method, which is further described in U.S. Pat. No. 5,804,610 (Hamer et al.) and 6,294,249 (Hamer et al.), is particularly advantageous when the first (meth)acrylate polymer is subsequently combined with the other components of the crosslinkable composition using hot melt processing methods.

Polymerization of the first reaction mixture in the presence of a photoinitiator such as those described above usually occurs upon exposure to UV radiation. Suitable UV sources often have at least 60 percent, at least 65 percent, at least 70 percent, or at least 75 percent of the emission spectra within the range of 280 to 400 nanometers and have an intensity within the range of 0.1 to 25 mW/cm 2. The temperature of the reaction mixture is often controlled by immersing the sealed polymeric pouch in a water bath or heat transfer fluid controlled at a temperature in a range of 5° C. to 50° C., 5° C. to 40° C., 5° C. to 30° C., or 5° C. to 20° C.

Polymerization in the presence of a thermal initiator can occur in a single step or in multiple steps. That is, all or a portion of the monomers and/or thermal initiator may be charged into a suitable reaction vessel and polymerized. In some embodiments, there is an initial charge of monomers and thermal initiator followed by partial polymerization. Polymerization is completed after the addition of any remaining monomers and/or thermal initiator. Multiple polymerization steps can help narrow the polydispersity of the polymerized product (e.g., the amount of low molecular weight chains can be reduced), can help minimize or control the heat of reaction, and can allow for adjustment of the type and amount of monomer available during polymerization. In some embodiments, polymerization occurs using an adiabatic process such as that described in U.S. Pat. No. 5,986,011 (Ellis et al.) and 5,637,646 (Ellis).

Polymerization in the presence of a thermal initiator such as those described above occurs upon heating above room temperatures such as in a range of 30° C. to 180° C. For example, the temperature can be at least 30° C., at least 40° C., at least 50° C., at least 60° C., at least 80° C., at least 100° C., at least 120° C., at least 140° C., or at least 150° C. and up to 180° C., up to 160° C., up to 150° C., up to 140° C., up to 120° C., up to 100° C., up to 80° C., or up to 60° C.

The first (meth)acrylate polymer is usually a random polymer. The first (meth)acrylate polymer is the base polymeric material for the crosslinked composition. The weight average molecular weight is often in a range of 100,000 Daltons to 1,500,000 Daltons. The adhesive properties of the crosslinked composition tend to improve with an increase in the weight average molecular weight (Mw) of the first (meth)acrylate polymer. If the weight average molecular weight is too great, however, the viscosity of the first (meth)acrylate polymer may be too high for extruding the crosslinkable composition onto a substrate for preparation of an adhesive article. The first (meth)acrylate polymer often has a weight average molecular weight equal to at least 100,000 Daltons, at least 125,000 Daltons, at least 150,000 Daltons, at least 200,000 Daltons, at least 250,000 Daltons, at least 300,000 Daltons, or at least 350,000 Daltons. The weight average molecular weight can be up to 1,500,000 Daltons, up to 1,200,000 Daltons, up to 1,000,000 Daltons, up to 800,000 Daltons, up to 750,000 Daltons, up to 600,000 Daltons, up to 500,000 Daltons, or up to 400,000 Daltons. The weight average molecular weight can be varied, for example, by altering the amount of chain transfer agent included in the first reaction mixture. The weight average molecular weight can be determined using Gel Permeation Chromatography as described more fully in the Examples section.

The first (meth)acrylate polymer typically has a glass transition temperature no greater than 60° C., no greater than 50° C., no greater than 40° C., no greater than 30° C., no greater than 20° C., no greater than 10° C., no greater than 0° C., no greater than −10° C., or no greater than −20° C. The glass transition temperature is typically greater than −50° C. The glass transition temperature can be measured using Dynamic Mechanical Analysis as described in the Examples section.

There can be a blend of different first (meth)acrylate polymers in the crosslinkable composition that differ in composition and/or molecular weight provided that each different first (meth)acrylate polymer in the blend has the requisite composition and weight average molecular weight.

### Second (Meth)Acrylate Polymer

The second (meth)acrylate polymer in the crosslinkable composition has a different composition and weight average molecular weight compared to the first (meth)acrylate polymer. In particular, the second (meth)acrylate has a weight average molecular weight of at least 5,000 Daltons to less than 100,000 Daltons. The second (meth)acrylate polymer contains 1) monomeric units derived from an alkyl (meth)acrylate, 2) monomeric units derived from a hydroxy-containing monomer in an amount ranging from 15 weight percent to 70 weight percent based on a total weight of monomeric units in the second (meth)acylate polymer, and 3) crosslinking monomeric units having a pendant (meth)acryloyl group.

The second (meth)acrylate polymer is prepared from a second precursor polymer that is formed from a second reaction mixture that contains an alkyl (meth)acrylate, hydroxy-containing monomers, and any other optional monomers. Typically, some of the resulting hydroxy-containing monomeric units in the precursor polymer are subsequently reacted with an unsaturated reagent compound to provide the second (meth)acrylate polymer that contains monomeric units having a pendant (meth)acryloyl group.

The monomeric units derived from alkyl (meth)acrylates that are suitable for use in the second (meth)acylate polymer (and in the second precursor polymer) are the same as those described above for use in the first (meth)acrylate polymer. The second (meth)acrylate polymer often contains 5 to 85 weight percent monomeric units derived from an alkyl (meth)acrylate based on total weight of monomeric units in the second (meth)acrylate polymer. For example, the second (meth)acrylate polymer can contain up to 80 weight percent, up to 75 weight percent, up to 70 weight percent, up to 65 weight percent, or up to 60 weight percent monomeric units derived from an alkyl (meth)acrylate. The second (meth)acrylate polymer often contains at least 5 weight percent, at least 10 weight percent, at least 15 weight percent, at least 20 weight percent, at least 25 weight percent, at least 30 weight percent, at least 40 weight percent, at least 50 weight percent, at least 55 weight percent, at least 60 weight percent, at least 65 weight percent, at least 70 weight percent, or at least 75 weight percent of the alkyl (meth)acrylate.

The second (meth)acylate polymer (and the second precursor) also contains monomeric units derived from a hydroxy-containing monomer. Suitable hydroxy-containing monomers are the same as those described above for preparation of the first (meth)acylate polymer. The amount of the hydroxy-containing monomeric units in the second (meth)acrylate polymer is in a range of weight percent to 70 weight percent based on the total weight of monomeric units in the second (meth)acylate polymer. The amount is usually at least 15 weight percent, at least 20 weight percent, at least 25 weight percent, at least 30 weight percent, at least 35 weight percent and up to 70 weight percent, up to 60 weight percent, up to 50 weight percent, up to 45 weight percent, up to weight percent, up to 30 weight percent, or up to 25 weight percent.

The hydroxy-containing monomeric units included in the second (meth)acrylate polymer tend to enhance the performance and/or properties of the final crosslinked composition, which is typically a pressure-sensitive adhesive or heat bondable adhesive. First, increasing the content of hydroxy-containing monomeric units tends to increase the dielectric constant of the crosslinked composition. The increased dielectric constant is desirable for use of the adhesive in electronic application such as, for example, electronic displays. Additionally, the adhesive strength to many of the substrates found in an electric device tends to increase as the amount of hydroxy-containing monomeric units included in the second (meth)acylate polymer increases. The use of hydroxy-containing monomeric units can increase the adhesive strength without the use of acidic groups that may adversely impact the lifetime of an electronic device through corrosion and/or dissolution of metal components. Still further, the hydroxy-containing monomeric units can influence the clarity of the crosslinked composition in high humidity environments such as at least 70 percent relative humidity. That is, the hydroxy-containing monomeric units can help reduce the amount of haziness that occurs when the crosslinked compositions are exposed to high humidity conditions. This reduction in haziness can be important for use of the adhesive in applications where clarity (including optical clarity) is important.

The amount of hydroxy-containing monomeric units in the second (meth)acrylate polymer is higher than the amount of hydroxy-containing monomeric units in the first (meth)acrylate polymer. If more than 10 weight percent hydroxy-containing monomeric units are included in the first (meth)acrylate polymer, the effect of transesterification reactions can become more problematic at elevated temperatures (e.g., about 120° C. or above) resulting in the viscosity becoming too high. Transesterification reactions can occur during preparation of the first (meth)acrylate polymer at elevated temperatures and/or when processing (e.g., extruding) the crosslinkable composition.

Transesterification reactions tend to increase the viscosity of the first (meth)acrylate polymer, leading to gel defect formation or unacceptable coating quality. This is due to crosslinking of polymer chains and the resulting increase in average molecular weight. While transesterification can occur within the second (meth)acrylate polymer as well, the effect on viscosity of the crosslinkable composition is considerably less than with the first (meth)acrylate polymer because of the lower molecular weight of the second (meth)acrylate polymer and the comparatively lower amount of second (meth)acrylate polymer in the crosslinkable composition. By placing most or all the hydroxy-containing monomeric units in the second (meth)acrylate polymer rather than in the first (meth)acrylate polymer, viscosity increases and gelation during processing can be avoided or minimized and defect free coatings are more readily achieved.

The second (meth)acrylate polymer can include other optional monomeric units such as those described above for the first (meth)acrylate polymer. For example, the second (meth)acylate polymer can include non-hydroxy-containing polar monomeric units. Any non-hydroxy-containing polar monomeric unit described for use in the first (meth)acrylate polymer can be used in the second (meth)acrylate polymer.

The optional non-hydroxy-containing polar monomeric unit can be included in an amount in a range of 0 to 25 weight percent based on total weight of the second (meth)acrylate polymer (and the second precursor polymer). In many embodiments, this monomeric unit is present in an amount up to 15 weight percent, up to 10 weight percent, or up to 5 weight percent based on total weight of the second (meth)acrylate polymer. If present, the second (meth)acylate polymer often contains at least 0.5 weight percent, at least 1 weight percent, at least 2 weight percent, at least 3 weight percent, or at least 5 weight percent non-hydroxy-containing polar monomeric unit. In some embodiments, the second (meth)acrylate polymer contains non-hydroxy-containing polar monomeric units with basic groups such as primary amido groups, secondary amido groups, or amino groups.

As with the first reaction mixture used to form the first (meth)acrylate polymer, any other optional monomers compatible with (e.g., miscible with) the monomers in the second reaction mixture used to form the second precursor polymer can be included. Examples of other monomers include various aryl (meth)acrylate (e.g., phenyl (meth)acrylate), vinyl ethers, vinyl esters (e.g., vinyl acetate), olefinic monomers (e.g., ethylene propylene, or butylene), styrene, styrene derivatives (e.g., alpha-methyl styrene), and the like. Still other example monomers are aryl substituted alkyl (meth)acrylates or alkoxy substituted alkyl (meth)acrylates such as 2-biphenylhexyl (meth)acrylate, benzyl (meth)acrylate, and 2-phenoxy ethyl (meth)acrylate. In many embodiments the (meth)acrylate is an acrylate. The second reaction mixture typically does not include a monomer with multiple (meth)acryloyl groups or multiple vinyl groups.

The second reaction mixture used to prepare the second precursor polymer typically includes a free radical initiator. As with the first reaction mixture used to form the first (meth)acrylate polymer or the first precursor polymer, the free radical initiator can be either a thermal initiator or a photoinitiator. Suitable thermal initiators and photoinitiators for the second reaction mixture are the same as described above for the first reaction mixture.

Other components can be added to the second reaction mixture used to form the second precursor polymer. In some embodiments, chain transfer agents such as those described above for use in the first reaction mixture can be added to control the molecular weight of the second precursor polymer. The amount of the chain transfer agent can be up to 8 weight percent, up to 6 weight percent, up to 4 weight percent, up to 2 weight percent, up to 1 weight percent, or up to 0.5 weight percent based on a total weight of monomers in the second reaction mixture. The amount is often at least 0.005 weight percent, at least 0.01 weight percent, at least 0.05 weight percent, at least 0.1 weight percent, at least 0.5 weight percent, or at least 1 weight percent based on the total weight of monomers.

In many embodiments, the polymerization reaction to form the second precursor polymer occurs with little or no organic solvent present. That is, the second reaction mixture is free of organic solvent or contains a minimum amount of organic solvent. If desired, an organic solvent can be added to control the viscosity of the second reaction mixture and/or to effectively remove the second precursor polymer from the reactor. Suitable organic solvents include those described above for use in the first reaction mixture. If used, the organic solvent is often present in an amount up to 100 parts per hundred (100 pph) of the monomers or even greater. The amount can be up to 80 pph, up to 60 pph, up to 40 pph, up to 10 pph, or up to 5 pph. If used, any organic solvent typically is removed at the completion of the polymerization reaction.

The second precursor polymer can be polymerized using any of the polymerization processes described above for preparation of the first (meth)acrylate polymer (or the first precursor polymer if the first (meth)acrylate polymer has pendant (meth)acryloyl groups).

The second (meth)acrylate polymer is the reaction product of a second precursor polymer with an unsaturated reagent compound. Suitable pendant groups on the second precursor polymer and unsaturated reagent compounds that can be used are the same as described for preparing the first (meth)acrylate polymer from the first precursor polymer. In most embodiments, however, because of the large amount of hydroxy-containing monomeric units in the second precursor polymer, the addition of the pendant (meth)acryloyl group is through a reaction between the hydroxy-containing monomeric units of the second precursor polymer. Any unsaturated reagent compound having both a group reactive with a hydroxy group and having a (meth)acryloyl group can be used. In many embodiments, the pendant hydroxy group of the hydroxy-containing monomeric units in the second precursor, which are of formula —(CO)—O—R⁴—OH, are reacted with an isocyanatoalkyl (meth)acrylate of formula H₂C═CHR¹—(CO)—O—R³—NCO as the unsaturated reagent compound. The reaction provides the second (meth)acrylate polymer having (meth)acryloyl-containing pendant groups of formula —(CO)—O—R⁴—O—(CO)—NH—R³—O—(CO)—CHR¹═CH₂. Groups R⁴ and R³ are each independently an alkylene group such as an alkylene having 1 to 10 carbon atoms, 1 to 6 carbon atoms, or 1 to 4 carbon atoms. R¹ is methyl or hydrogen.

The resulting second (meth)acrylate polymer has 0.3 to 20 weight percent monomeric units having a (meth)acryloyl group based on a weight of all monomeric units in the second (meth)acrylate polymer. The amount can be at least 0.3 weight percent, at least 0.5 weight percent, at least 1 weight percent, at least 2 weight percent, at least 3 weight percent, or at least 5 weight percent and up to 20 weight percent, up to 15 weight percent, up to 10 weight percent, up to weight percent, or up to 3 weight percent. The amount is based on a total weight of monomeric units in the second (meth)acylate polymer.

The second (meth)acrylate polymer has an average of at least one pendant (meth)acryloyl group per polymer chain. The number of pendant (meth)acryloyl groups per polymer chain is dependent on the molecular weight. As the weight average molecular weight approaches 100,000 Daltons, there can be up to an average of about 120 pendant (meth)acryloyl groups per polymer. As the weight average molecular weight approaches 5,000 Daltons, however, there can be up to an average of about 6 pendant (meth)acryloyl groups per polymer. Thus, there can be an average of at least 1, at least 2, at least 3, at least 5, at least 10, at least 20, at least 40, or at least 50 and up to 120, up to 100, up to 80, up to 60, up to 50, up to 40, up to 20, up to 10 pendant, up to 6, up to 5, or up to 3 (meth)acryloyl groups per polymer.

Some exemplary second (meth)acrylate polymers contain up to 85 weight percent monomeric units derived from an alkyl (meth)acrylate, at least 15 weight percent monomeric units derived from a hydroxy-containing monomer, and at least 0.3 weight percent crosslinking monomeric units having a pendant (meth)acryloyl group based on the total weight of monomeric units in the second (meth)acrylate polymer. For example, the second (meth)acrylate polymer can contain 5 to 85 weight percent monomeric units derived from an alkyl (meth)acrylate, 15 to 70 weight percent hydroxy-containing monomeric units, 0 to 20 weight percent non-hydroxy-containing polar monomeric units, and 0.3 to 20 weight percent crosslinking monomeric units having a pendant (meth)acryloyl group.

In more specific examples, the second (meth)acrylate polymer can contain 30 to 85 weight percent monomeric units derived from an alkyl (meth)acrylate, 15 to 60 weight percent hydroxy-containing monomeric units, 0 to 15 weight percent non-hydroxy-containing polar monomeric units, and 0.3 to 20 weight percent crosslinking monomeric units having a pendant (meth)acryloyl group. In other more specific examples, the second (meth)acrylate polymer can contain 50 to 85 weight percent monomeric units derived from an alkyl (meth)acrylate, 25 to 50 weight percent hydroxy-containing monomeric units, 0 to 10 weight percent non-hydroxy-containing polar monomeric units, and 0.3 to 20 weight percent crosslinking monomeric units having a pendant (meth)acryloyl group.

The weight average molecular weight of the second (meth)acrylate polymer is lower than the weight average molecular weight of the first (meth)acrylate polymer. The lower molecular weight of the second (meth)acrylate polymer can be used to minimize the impact of transesterification reactions on the overall viscosity of the crosslinkable composition when the crosslinkable composition is heated at elevated temperatures. The second (meth)acrylate polymer, which is a random polymer, typically has a weight average molecular weight in a range of 5,000 to 100,000 Daltons. If the weight average molecular weight is too high, it will have a higher viscosity and may be more difficult to blend with the first (meth)acrylate polymer. In some embodiments, the weight average molecular weight of the second (meth)acrylate polymer is at 5,000 Daltons, at least 7,500 Daltons, at least 10,000 Daltons, at least 20,000 Daltons, at least 30,000 Daltons, at least 40,000 Daltons, or at least 50,000 Daltons and up to 100,000 Daltons, up to 90,000 Daltons, up to 80,000 Daltons, up to 70,000 Daltons, up to 60,000 Daltons, or up to 50,000 Daltons. The weight average molecular weight can be varied, for example, by altering the amount of chain transfer agent included in the first reaction mixture. The weight average molecular weight can be determined using Gel Permeation Chromatography as described more fully in the Examples section.

The glass transition temperature of the second (meth)acrylate polymer can vary to a greater extent than the first (meth)acrylate polymer because it is present in a smaller amount and has a lower weight average molecular weight. The glass transition temperature can be up to 100° C., up to 80° C., up to 60° C., up to 50° C., up to 40° C., up to 30° C., or up to 25° C. The glass transition temperature is usually at least −50° C., at least −20° C., or at least 0° C.

There can be a blend of different second (meth)acrylate polymers in the crosslinkable composition that differ in composition and/or molecular weight provided that each different second (meth)acrylate polymer in the blend has the requisite composition and weight average molecular weight.

### Overall Crosslinkable Composition

The amount of the first (meth)acrylate polymer in the crosslinkable composition is often in a range of 50 to 95 weight percent based on a total weight of polymeric material (e.g., the total weight of (meth)acrylate polymers, which is typically the sum of the amount of the first (meth)acrylate polymer and the second (meth)acrylate polymer) in the crosslinkable composition). For example, the crosslinkable composition can include at least 50 weight percent, at least 55 percent, at least 60 weight percent, at least 65 weight percent, at least 70 weight percent, at least 75 weight percent, or at least 80 weight percent of the first (meth)acrylate polymer. The amount of the first (meth)acrylate polymer can be up to 95 weight percent, up to 90 weight percent, up to 85 weight percent, up to 80 weight percent, up to 75 weight percent, or up to 70 weight percent based on the total weight of polymeric materials in the crosslinkable composition.

The amount of the second (meth)acrylate polymer in the crosslinkable composition is often in a range of 5 to 50 weight percent based on a total weight of polymeric material in the crosslinkable composition. For example, the crosslinkable composition can include at least 5 weight percent, at least 10 weight percent, at least 15 weight percent, at least 20 weight percent, or at least 25 weight percent of the second (meth)acrylate polymer. The amount of the second (meth)acrylate polymer can be up to 50 weight percent, up to 45 weight percent, up to 40 weight percent, up to 35 weight percent, or up to 30 weight percent based on the total weight of polymeric material in the crosslinkable composition.

In summary, the crosslinkable composition contains 50 to 95 weight percent of the first (meth)acrylate polymer and 5 to 50 weight percent of the second (meth)acrylate polymer based on the total weight of polymeric material in the crosslinkable composition. If the amount of the second (meth)acrylate polymer is present in a lower amount, there may not be enough hydroxy-containing monomeric units in the overall crosslinkable composition to achieve the advantages associated with its presence. If the amount of the second (meth)acrylate polymer is present in a higher amount, however, there may be incompatibility between the two (meth)acrylate polymers as evidenced by a haze value greater than about 5 percent, greater than 4, or greater than 3. Measurement of haze is described more fully in the Examples section.

In some embodiments, the crosslinkable composition contains 50 to 90 weight percent of the first (meth)acrylate polymer and 10 to 50 weight percent of the second (meth)acrylate polymer based on the total weight of polymeric material in the crosslinkable composition. For example, the crosslinkable composition can contain 50 to 80 weight percent of the first (meth)acrylate polymer and 20 to 50 weight percent of the second (meth)acrylate polymer, or 60 to 80 weight percent of the first (meth)acrylate polymer and 20 to 40 weight percent of the second (meth)acrylate polymer.

Other optional crosslinking monomers having multiple (meth)acryloyl groups can be added to the crosslinkable composition. These crosslinking monomers can be added to adjust the crosslink density of the cured composition. That is, these crosslinking monomers can be added to the curable composition after it has been formed. The crosslinking monomers can react with pendant (meth)acryloyl groups of the second (meth)acrylate polymer when exposed to ultraviolet or visible light radiation in the presence of a photoinitiator. If added, the amount of the optional crosslinking monomer is typically in the range of 0 to 30 parts per hundred (pph) based on the weight of the curable (meth)acrylate copolymer. For example, the amount can be at least 1 pph, at least 2 pph, or at least 5 pph and can be up to 30 pph, up to 25 pph, up to 20 pph, up to 15 pph, or up to 10 pph.

Example crosslinking monomers with two (meth)acryloyl groups include 1,2-ethanediol diacrylate, 1,3-propanediol diacrylate, 1,9-nonanediol diacrylate, 1,12-dodecanediol diacrylate, 1,4-butanediol diacrylate, 1,6-hexanediol diacrylate, butylene glycol diacrylate, bisphenol A diacrylate, diethylene glycol diacrylate, triethylene glycol diacrylate, tetraethylene glycol diacrylate, tripropylene glycol diacrylate, polyethylene glycol diacrylate (e.g., commercially available from Sartomer under the trade designation SR-210, SR-252, and SR-603), polypropylene glycol diacrylate, polyethylene/polypropylene copolymer diacrylate, neopentylglycol hydroxypivalate diacrylate modified caprolactone, and polyurethane diacrylates (e.g., commercially available from Sartomer under the trade designation CN9018 and CN983).

Exemplary crosslinking monomers with three or four (meth)acryloyl groups include, but are not limited to, trimethylolpropane triacrylate (e.g., commercially available under the trade designation TMPTA-N from Surface Specialties, Smyrna, GA, and under the trade designation SR-351 from Sartomer, Exton, PA), pentaerythritol triacrylate (e.g., commercially available under the trade designation SR-444 from Sartomer), tris(2-hydroxyethylisocyanurate) triacrylate (commercially available under the trade designation SR-368 from Sartomer), a mixture of pentaerythritol triacrylate and pentaerythritol tetraacrylate (e.g., commercially available from Surface Specialties under the trade designation PETIA with an approximately 1:1 ratio of tetraacrylate to triacrylate, and under the trade designation PETA-K with an approximately 3:1 ratio of tetraacrylate to triacrylate), pentaerythritol tetraacrylate (e.g., commercially available under the trade designation SR-295 from Sartomer), di-trimethylolpropane tetraacrylate (e.g., commercially available under the trade designation SR-355 from Sartomer), and ethoxylated pentaerythritol tetraacrylate (e.g., commercially available under the trade designation SR-494 from Sartomer). An exemplary crosslinking monomer with five (meth)acryloyl groups includes, but is not limited to, dipentaerythritol pentaacrylate (e.g., commercially available under the trade designation SR-399 from Sartomer).

Other suitable crosslinking monomers are urethane oligomers having at least two (meth)acryloyl groups. These crosslinking monomers can be synthesized, for example, by reacting a multifunctional isocyanate compound having at least two isocyanate groups with a polyol having at least two hydroxy groups to yield an isocyanate terminated urethane prepolymer. Subsequently, acrylates or methacrylates having a hydroxyl group can then be reacted with the terminal isocyanate groups of the prepolymer. Both aromatic and aliphatic multifunctional isocyanate compounds can be used to prepare the prepolymer. Examples of diisocyanates include, but are not limited to, 2,4-tolylene diisocyanate, 2,6-tolylene diiscyanate, 1,3-xylylene diisocyanate, 1,4-xylylene diisocyanate, 1,6-hexane diisocyanate, isophorone diisocyanate and the like. Examples of hydroxy terminated (meth)acrylates useful for reacting with the prepolymer to introduce (meth)acryloyl groups include, but are not limited to, 2-hydroxyethyl (meth)acrylate, 2-hydroxypropyl (meth)acrylate, 4-hydroxybutyl acrylate, polyethylene glycol (meth)acrylate and the like. Suitable urethane oligomeric crosslinkers are also commercially available such as, for example, CN962, CN964, CN965, CN934, and CN 972 from Sartomer Co. (Exton, PA) and ACTILANE 130, 170, 270, and 290 from Akzo Nobel Resins (Baxley, GA), GENOMER 4269 from Rahn USA Corp. (Aurora, IL), and EBECRYL 230, 270, 8803, 4827, and 6700 from UCB Chemicals (Smyma, GA).

The crosslinkable composition can optionally further include a Type I photoinitiator. Type I photoinitiators function by an alpha-cleavage that forms two radical species. These two radicals can form crosslinks between polymeric chains or within the same polymeric chain. Example Type I photoinitiators include benzoin ethers such as benzoin methyl ether and benzoin isopropyl ether; substituted acetophenones such as 2,2-dimethoxyacetophenone available as IRGACURE 651 photoinitiator (Ciba Specialty Chemicals), 2,2 dimethoxy-2-phenyl-1-phenylethanone available as ESACURE KB-1 photoinitiator (Sartomer Co., West Chester, PA), 1-[4-(2-hydroxyethoxy)phenyl]-2-hydroxy-2-methyl-1-propan-1-one available as IRGACURE 2959 (Ciba Specialty Chemicals), and dimethoxyhydroxyacetophenone; substituted α-ketols such as 2-methyl-2-hydroxy propiophenone; aromatic sulfonyl chlorides such as 2-naphthalene-sulfonyl chloride; photoactive oximes such as 1-phenyl-1,2-propanedione-2-(O-ethoxy-carbonyl)oxime; and the like; and combinations thereof.

The crosslinkable composition optionally includes a tackifier. The tackifier is typically selected to be miscible with the two (meth)acrylate polymers. Either solid or liquid tackifiers can be added. Solid tackifiers generally have a number average molecular weight (Mn) of 10,000 Daltons or less and a softening point above about 70° C. Liquid tackifiers are viscous materials that have a softening point of about 0° C. to about 70° C.

Suitable tackifying resins include rosin resins such as rosin acids and their derivatives (e.g., rosin esters); terpene resins such as polyterpenes (e.g., alpha pinene-based resins, beta pinene-based resins, and limonene-based resins) and aromatic-modified polyterpene resins (e.g., phenol modified polyterpene resins); coumarone-indene resins; and petroleum-based hydrocarbon resins such as C5-based hydrocarbon resins, C9-based hydrocarbon resins, C5/C9-based hydrocarbon resins, and dicyclopentadiene-based resins. These tackifying resins, if added, can be hydrogenated to lower their color contribution to the pressure-sensitive adhesive composition. Combinations of various tackifiers can be used, if desired. In many embodiments, the tackifier is a rosin ester or includes a rosin ester.

Tackifiers that are rosin esters are the reaction products of various rosin acids and alcohols. These include, but are not limited to, methyl esters of rosin acids, triethylene glycol esters of rosin acids, glycerol esters of rosin acids, and pentaertythritol esters of rosin acids. These rosin esters can be hydrogenated partially or fully to improve stability and reduce their color contribution to the pressure-sensitive adhesive composition. The rosin resin tackifiers are commercially available, for example, from Eastman Chemical Company (Kingsport, TN, USA) under the trade designations PERMALYN, STAYBELITE, and FORAL as well as from Newport Industries (London, England) under the trade designations NUROZ and NUTAC. A fully hydrogenated rosin resin is commercially available, for example, from Eastman Chemical Company under the trade designation FORAL AX-E. A partially hydrogenated rosin resin is commercially available, for example, from Eastman Chemical Company under the trade designation STAYBELITE-E.

Tackifiers that are hydrocarbon resins can be prepared from various petroleum-based feed stocks. These feedstocks can be aliphatic hydrocarbons (mainly C5 monomers with some other monomers present such as a mixture of trans-1,3-pentadiene, cis-1,3-pentadiene, 2-methyl-2-butene, dicyclopentadiene, cyclopentadiene, and cyclopentene), aromatic hydrocarbons (mainly C9 monomers with some other monomers present such as a mixture of vinyl toluenes, dicyclopenetadiene, indene, methylstyrene, styrene, and methylindenes), or mixtures thereof. Tackifiers derived from C5 monomers are referred to as C5-based hydrocarbon resins while those derived from C9 monomers are referred to as C9-based hydrocarbon resins. Some tackifiers are derived from a mixture of C5 and C9 monomers or are a blend of C5-based hydrocarbon tackifiers and C9-based hydrocarbon tackifiers. These tackifiers can be referred to as C5/C9-based hydrocarbon tackifiers. Any of these resins can be partially or fully hydrogenated to improve their color and thermal stability.

The C5-based hydrocarbon resins are commercially available from Eastman Chemical Company under the trade designations PICCOTAC and EASTOTAC, from Cray Valley (Exton, PA, USA) under the trade designation WINGTACK, from Neville Chemical Company (Pittsburgh, PA, USA) under the trade designation NEVTAC LX, and from Kolon Industries, Inc. (South Korea) under the trade designation HIKOREZ. The C5-based hydrocarbon resins are commercially available from Eastman Chemical with various degrees of hydrogenation under the trade designation EASTOTACK.

The C9-based hydrocarbon resins are commercially available from Eastman Chemical Company under the trade designation PICCO, KRISTLEX, PLASTOLYN, and PICCOTAC, and ENDEX, from Cray Valley (Exton, PA, USA) under the trade designations NORSOLENE, from Ruetgers N.V. (Belgium) under the trade designation NOVAREZ, and from Kolon Industries, Inc. (South Korea) under the trade designation HIKOTAC. These resins can be partially or fully hydrogenated. Prior to hydrogenation, the C9-based hydrocarbon resins are often about 40 percent aromatic as measured by proton Nuclear Magnetic Resonance. Hydrogenated C9-based hydrocarbon resins are commercially available, for example, from Eastman Chemical under the trade designations REGALITE and REGALREX that are 50 to 100 percent (e.g., 50 percent, 70 percent, 90 percent, and 100 percent) hydrogenated. The partially hydrogenated resins typically have some aromatic rings.

Various C5/C9-based hydrocarbon tackifiers are commercially available from Arakawa (Germany) under the trade designation ARKON, from Zeon Corporation (Japan) under the trade designation QUINTONE, from Exxon Mobile Chemical (Houston, TX) under the trade designation ESCOREZ, and from Newport Industries (London, England) under the trade designations NURES and H-REZ.

If present, the tackifier is often used in an amount equal to at least 1 weight percent based on a total weight of solids in the crosslinkable composition. As used herein, the term “solids” includes all materials other than water and organic solvents in the crosslinkable composition. The main contributors to the solids are the first (meth)acrylate polymer, the second (meth)acrylate polymer, and any optional tackifier. In some embodiments, the amount of tackifier is present in an amount of at least 5 weight percent, at least 10 weight percent, at least 15 weight percent, at least weight percent, at least 25 weight percent, at least 30 weight percent, or at least 35 weight percent based on the total weight of polymers (e.g., the total weight of the first and second (meth)acylate polymers) in the crosslinkable composition. The amount of the tackifier can be up to 60 weight percent or even higher, up to 55 weight percent, up to 50 weight percent, up to 45 weight percent, or up to 40 weight percent based on the total weight of the polymers in the crosslinkable composition. In some embodiments, the tackifier is present in an amount in a range of 0 to 60 weight percent, 1 to 60 weight percent, 5 to 60 weight percent, 10 to 60 weight percent, to 60 weight percent, 30 to 60 weight percent, 10 to 50 weight percent, 20 to 50 weight percent, to 50 weight percent, 20 to 45 weight percent, or 20 to 40 weight percent based on the total weight of polymers in the crosslinkable composition.

In some applications, it can be advantageous to include an adhesion promoter in the crosslinkable composition to optimize performance of the adhesive composition. This additive can promote adhesion between the adhesive composition and the substrate. In many embodiments, the adhesion promoters have a first group that can interact with the substrate and a second group that can interact with a component of the crosslinkable composition. For example, the first group of the adhesion promoter that can interact with the substrate may have a silyl group of formula —Si(R^{a})ₓ(R^{b})₃₋ₓ where R^{a} is an alkoxy, R^{b} is an alkyl, and x is 1, 2, or 3. Suitable alkyl and alkoxy groups for R^{a} and R^{b} often have 1 to 10, 1 to 6, or 1 to 4 carbon atoms. Comparable titanium-containing groups can be used in place of the silyl group. Such first groups are particularly useful for interacting with a substrate having silanol or hydroxy groups. In some embodiments, the second group of the adhesion promoter is a polymerizable group. The polymerizable group is generally a (meth)acryloyl group but vinyl and allyl groups may also be used. Alternatively, the second group can be a group that interacts with a monomeric unit in the first (meth)acrylate polymer or the second (meth)acrylate polymer. The interaction can include, for example, a chemical reaction, hydrogen bonding, an ionic interaction, or an acid-base interaction. An example of a suitable adhesion promoter is a silane such as (3-glycidyloxypropyl)trimethoxysilane that can react chemically with hydroxy-containing monomeric units in the crosslinkable composition and with the surface of a glass substrate. The adhesion promoter can be present in an amount ranging from 0 to 10 weight percent based on the total weight of polymers in the crosslinkable composition. The amount, if present, is often at least 0.1 weight percent, at least 0.2 weight percent, at least 0.5 weight percent, at least 1 weight percent, and up to 10 weight percent, up to 8 weight percent, up to 6 weight percent, or up to 5 weight percent.

Further optional components can be added to the crosslinkable composition such as, for example, heat stabilizers, antioxidants, antistatic agents, plasticizers, thickeners, fillers, pigments, dyes, colorants, thixotropic agents, processing aides, nanoparticles, fibers, and combinations thereof. Fillers can often be used in an amount ranging from 0 to 20 weight percent based on the weight of polymers in the crosslinkable compositions. The filler amount, if present, can be up to weight percent, up to 10 weight percent, or up to 5 weight percent and at least 1 weight percent, at least 2 weight percent, or at least 5 weight percent based on the weight of polymers in the crosslinkable compositions. The other optional components, if present, usually contribute in total up to 20 weight percent, up to 15 weight percent, up to 10 weight percent, up to 5 weight percent, up to 3 weight percent, up to 2 weight percent, or up 1 weight percent based on the weight of polymers in the crosslinkable composition.

The first (meth)acrylate polymer, the second (meth)acrylate polymer, and any optional components are blended to form the crosslinkable composition. Any suitable method of blending these components together can be used. The blending method can be done in the presence or absence of an organic solvent. In many embodiments, it can be advantageous to form a crosslinkable composition free or substantially free of an organic solvent. As used in reference to the crosslinkable composition, the term “substantially free” means that the total solids of the crosslinkable composition is greater than 90 weight percent, greater than 95 weight percent, greater than 97 weight percent, greater than 98 weight percent, or greater than 99 weight percent based on a total weight of the crosslinkable composition.

In many embodiments, the blending step includes mixing the various components in a molten state. Such blending methods can be referred to as hot melt mixing methods or hot melt blending methods. Both batch and continuous mixing equipment can be used. Examples of batch methods for blending components of the crosslinkable composition include those using a BRABENDER (e.g., a BRABENDER PREP CENTER that is commercially available from C.W. Brabender Instruments, Inc. (South Hackensack, NJ, USA)) or BANBURY internal mixing and roll milling equipment, which is available from Farrel Co. (Ansonia, CN, USA). Examples of continuous mixing methods include single screw extruding, twin screw extruding, disk extruding, reciprocating single screw extruding, and pin barrel single screw extruding. Continuous methods can utilize distributive elements, pin mixing elements, static mixing elements, and dispersive elements such as MADDOCK mixing elements and SAXTON mixing elements.

A single piece or multiple pieces of hot melt mixing equipment may be used to prepare the crosslinkable compositions. In some embodiments, it may be desirable to use more than one piece of hot melt mixing equipment. For example, a first extruder such as a single screw extruder can be used to hot melt process the first (meth)acrylate polymer contained within a thermoplastic pouch. The output of the first extruder can be fed into a second extruder such as a twin-screw extruder for hot melt mixing the first (meth)acrylate polymer with the second (meth)acrylate polymer, tackifier, or both. The output of the hot melt mixing process is a blended crosslinkable composition.

The blended or overall crosslinkable composition typically has a glass transition temperature that is up to 25° C. if the crosslinked composition is a pressure-sensitive adhesive or up to 60° C. if the crosslinked composition is a heat bondable adhesive. Suitable pressure-sensitive adhesives often have a glass transition temperature that is greater than −40° C., greater than −25° C., greater than −20° C., greater than −10° C., greater than 0° C. and up to 25° C., up to 20° C., up to 15° C., up to 10° C., or up to 0° C. Suitable heat bondable adhesives often have a glass transition temperature that is greater than 25° C., greater than 30° C., greater than 35° C., greater than 40° C. and up to 60° C., up to 50° C., or up to 40° C. In many embodiments, the overall crosslinkable composition has a glass transition temperature no greater than 30° C.

The blended crosslinkable composition can be applied as a coating to a substrate. If a batch apparatus is used, the hot melt blended crosslinkable composition can be removed from the apparatus and placed in a hot melt coater or extruder for coating onto a substrate. If an extruder is used, the hot melt blended crosslinkable composition can be directly extruded onto a substrate to form a coating.

Thus, in another aspect, an article is provided. The article includes a substrate and a layer of the crosslinkable composition positioned adjacent to the substrate. The crosslinkable composition is the same as described above and includes the first (meth)acrylate polymer, the second (meth)acrylate polymer, and any optional components. As used herein, the term “adjacent” refers to a first layer positioned near the second layer. The first and second layers can be in contact or can be separated from each other by another layer. For example, a substrate can be positioned adjacent to the crosslinkable composition if the substrate contacts the crosslinkable composition or is separated from the crosslinkable composition by another layer such as a primer layer or surface modification layer that increases the adhesion of the crosslinkable composition to the substrate. The crosslinkable composition is typically applied as a coating to a major surface of the substrate and the article is a substrate coated with the crosslinkable composition.

The expressions “coating of the crosslinkable composition”, “crosslinkable composition coating”, “layer of the crosslinkable composition”, “crosslinkable composition layer” and similar expressions are used interchangeably. Likewise, similar expressions for the crosslinked composition are used interchangeably.

The coating process can be performed using (meth)acrylate polymers that have little or no crosslinking. Such polymeric materials can easily flow under the typical hot melt processing conditions. Hot melt processing advantageously typically uses no organic solvents or minimal organic solvents. Thus, such processing methods are environmentally desirable. Using no organic solvent can also enable processing efficiencies and higher throughput by eliminating the time and equipment (ovens) need to evaporate the solvent from the coating. Moreover, thicker coatings can be achieved without the need for extended drying time, or the formation of bubbles within the coating.

Any suitable substrate can be used in the article. For example, the substrate can be flexible or inflexible and can be formed from a polymeric material, glass or ceramic material, metal, or combination thereof. Some substrates are polymeric films such as those prepared from polyolefins (e.g., polyethylene, polypropylene, or polymers thereof), polyurethanes, polyvinyl acetates, polyvinyl chlorides, polyesters (polyethylene terephthalate or polyethylene naphthalate), polycarbonates, polymethyl(meth)acrylates (PMMA), ethylene-vinyl acetate polymers, and cellulosic materials (e.g., cellulose acetate, cellulose triacetate, and ethyl cellulose). Other substrates are metal foils, nonwoven materials (e.g., paper, cloth, nonwoven scrims), foams (e.g., polyacrylic, polyethylene, polyurethane, neoprene), and the like. For some substrates, it may be desirable to treat the surface to improve adhesion to the crosslinked composition, crosslinked composition, or both. Such treatments include, for example, application of primer layers, surface modification layer (e.g., corona treatment or surface abrasion), or both.

In some embodiments, the substrate is a release liner. Release liners typically have low affinity for the crosslinkable composition or crosslinked composition. Exemplary release liners can be prepared from paper (e.g., Kraft paper) or other types of polymeric material. Some release liners are coated with an outer layer of a release agent such as a silicone-containing material or a fluorocarbon-containing material.

The crosslinkable composition coating can have any desired thickness that can be effectively crosslinked when exposed to ultraviolet radiation. In many embodiments, the crosslinkable composition coating has a thickness no greater than 20 mils (500 micrometers), no greater than 10 mils (250 micrometers), no greater than 5 mils (125 micrometers), no greater than 4 mils (100 micrometers), no greater than 3 mils (75 micrometers), or no greater than 2 mils (50 micrometers). The thickness is often at least 0.2 mils (5.0 micrometers) or at least 1 mil (25 micrometers). For example, the thickness of the crosslinkable composition coating can be in the range of 0.5 mils (12.5 micrometers) to 20 mils (500 micrometers), in the range of 0.5 mils (12.5 micrometers) to 10 mils (250 micrometers), in the range of 0.5 mils (12.5 micrometers) to 5 mils (125 micrometers), in the range of 1 mil (25 micrometers) to 3 mils (75 micrometers), or in the range of 1 mil (25 micrometers) to 2 mils (50 micrometers).

### Crosslinked Compositions and Articles

In other aspects, a crosslinked composition and an article containing the crosslinked composition are provided. The crosslinked composition is the reaction product of a crosslinkable composition exposed either to ultraviolet radiation or ionizing radiation. The article includes a substrate and a crosslinked composition layer positioned adjacent to the substrate. The substrate and the crosslinkable composition used to form the crosslinked composition are the same as described above.

Crosslinking of the crosslinkable composition can occur upon exposure to UV radiation. Suitable ultraviolet radiation crosslinking includes exposure of the crosslinkable composition to a UV light source. Such light sources can be either 1) relatively low light intensity sources such as blacklights or 2) relatively high light intensity sources such as mercury vapor lamps. Blacklights usually provide 10 mW/cm² or less (as measured in accordance with procedures approved by the United States National Institute of Standards and Technology as, for example, with a UVIMAP™ UM 365 L-S radiometer manufactured by Electronic Instrumentation & Technology, Inc., in Sterling, VA) over a wavelength range of 280 to 400 nanometers. Medium pressure mercury lamps often provide intensities generally greater than 10 mWatts/cm², preferably between 15 and 450 mWatts/cm². The total UV dosage is often in a range of 0.1 to 10 Joules/cm².

Alternatively, crosslinking of the crosslinkable composition can occur upon exposure to ionizing radiation. Non-limiting examples of ionizing radiation include alpha, beta, gamma, electron-beam, and x-ray radiation. Of these sources of ionizing radiation, electron-beam irradiation and gamma irradiation are preferred. Low voltage sources of electron-beam radiation are commercially available from Energy Sciences Inc., PCT Industries and Advanced Electron Beam (AEB). Sources of gamma irradiation are commercially available from Atomic Energy of Canada, Inc. using a cobalt-60 high-energy source. Ionizing radiation dosages are measured in kilograys (kGy). Doses of ionizing radiation can be administered in a single dose of the desired level of ionizing radiation or in multiple doses which accumulate to the desired level of ionizing radiation. The dosage of ionizing radiation cumulatively can range from about 25 kGy to about 400 kGy and preferably from about 25 kGy to about 200 kGy.

The crosslinked composition is typically a pressure-sensitive adhesive or a heat bondable adhesive. Thus, articles with a layer of the crosslinked composition can be used for many applications typical of pressure-sensitive adhesive articles and heat bondable adhesive articles. The substrate adjacent to the adhesive layer can be selected depending on the particular use or application. For example, the substrate can be a sheeting material and the resulting article can provide decorative graphics or can be a reflective product. In other examples, the substrate can be label stock (the resulting article is a label with an adhesive layer) or tape backing (the resulting article is an adhesive tape). In yet other examples, the substrate can be a release liner and the resulting article can be a transfer tape. The transfer tape can be used to transfer the pressure-sensitive adhesive layer to another substrate or surface. Other substrates and surfaces include, for example, a panel (e.g., a metal panel such as an automotive panel), glass (e.g., such as a window), or a component of an electronic device such as an electronic display.

Some articles are adhesive tapes. The adhesive tapes can be single-sided adhesive tapes with the crosslinkable composition attached to a single side of the tape backing or can be double-sided adhesive tape with a pressure-sensitive adhesive layer on both major surfaces of the tape backing. At least one of the two adhesive layers is the crosslinkable composition described above. Double-sided adhesive tapes are often carried on a release liner.

The crosslinked composition advantageously has a dielectric constant suitable for use in electronic devices. The dielectric constant at 100 kilohertz is often preferably at least 4.0, at least 4.1, at least 4.2, at least 4.3, or even higher. The dielectric constant can be achieved with minimal changes to the weight average molecular weight of the first and second (meth)acrylate polymers when heated under conditions suitable for extrusion. Thus, the two (meth)acrylate polymers can be blended, heated, and extruded onto a substrate without substantial increases in viscosity and crosslinking prior to positioning adjacent to a substrate. The viscosity and crosslinking can be controlled by using a high molecular weight first (meth)acrylate polymer with little or no hydroxy-containing monomeric units (0 to 10 weight percent) in combination with a low molecular weight second (meth)acrylate polymer having enough hydroxy-containing monomeric units (15 to 70 weight percent) to enhance the dielectric constant of the crosslinked composition.

The percent haze (as measured in the Example section) of the crosslinked compositions is generally low (e.g., no greater than 4 percent), indicating that the crosslinked compositions can be used in applications requiring optical clarity.

In yet another aspect, a method of preparing an article is provided. The method includes providing a substrate, positioning a crosslinkable composition adjacent to the substrate, and then exposing the crosslinkable composition to ultraviolet light or ionizing radiation to form a crosslinked composition. The crosslinkable composition is the same as described above.

In many embodiments of this method, the crosslinkable composition is positioned adjacent to the substrate by extruding the crosslinkable composition in a molten state. The various components of the crosslinkable composition are combined as a hot melt prior to extrusion. That is, the substrate is coated with the hot melt blended crosslinkable composition that exits the extruder. The extruded coating of the crosslinkable composition can be crosslinked upon exposure to UV radiation or ionizing radiation. Such methods allow the separation of the coating process from the crosslinking reactions needed to provide the good cohesive strength and shear holding power.

### EXAMPLES

Unless otherwise noted or readily apparent from the context, all parts, percentages, ratios, etc. in the Examples and the rest of the specification are by weight.

TABLE 1
Materials Used in the Examples

| Abbreviation | Description and Source |
|---|---|
| nBA | n-butylacrylate, obtained from Millipore Sigma, Saint Louis, MO |
| 2EHA | 2-ethylhexyl acrylate, obtained from Millipore Sigma, Saint Louis, MO |
| IBOA | Isbornyl acrylate, obtained from Millipore Sigma, Saint Louis, MO |
| HPA | Hydroxypropyl acrylate, obtained from San Esters Corp., New York, NY |
| ACM | Acrylamide, obtained from Alfa Aesar, Haverhill, MA |
| AEBP | Acryloxyethyl benzophenone, obtained from 3M Company, Saint Paul, |
| | MN |
| VAZO 52 | 2,2′-azobis(2,4-dimethylpentanenitrile), obtained under trade designation |
| | “VAZO 52” from Chemours, Wilmington, DE |
| EtOAc | Ethyl acetate, obtained from VWR Chemicals, Radnor, PA |
| MEK | Methyl ethyl ketone, obtained from Millipore Sigma, Saint Louis, MO |
| TDDM | Tert-dodecyl mercaptan, obtained from TCI America, Portland, OR |
| IOTG | Isooctyl thioglycolate, obtained from TCI America, Portland, OR |
| IEM | 2-isocyanatoethyl methacrylate, obtained from Showa Denko, Tokyo, |
| | Japan |
| OMNIRAD TPO | Diphenyl(2,4,6-trimethylbenzoyl)phosphine oxide, obtained under trade |
| | designation “OMNIRAD TPO” from IGM Resins USA Inc., Charlotte, |
| | NC |

### Test Methods

### Test Method 1: Molecular Weight Analysis Using GPC

The molecular weight distribution of the polymers was characterized using gel permeation chromatography (GPC). The GPC instrumentation, which was obtained from Waters Corporation (Milford, MA), included a high-pressure liquid chromatography pump (Model Alliance e2695), a UV detector (Model 2489), and a refractive index detector (Model 2414). The chromatograph was equipped with two STYRAGEL HR 5E 5-micron mixed bed columns, available from Waters Corporation.

GPC samples were prepared by dissolving polymer samples in tetrahydrofuran at a concentration of 0.5 percent (weight/volume) and filtering through a 0.2-micron polytetrafluoroethylene filter that is available from VWR International (West Chester, PA). The resulting samples were injected into the GPC and eluted at a rate of 1 milliliter per minute through the columns maintained at 35° C. The system was calibrated with polystyrene standards using a linear least square fit analysis to establish a calibration curve. The weight average molecular weight (Mw) and z-average molecular weight (Mz) were calculated for each sample against this standard calibration curve.

### Test Method 2: Dynamic Mechanical Analysis

The glass transition temperature (T_{g}) was measured via dynamic mechanical analysis (DMA) in shear mode on a DHR-3 rheometer from TA Instruments (New Castle, DE) equipped with 8 mm parallel plates. DMA samples were prepared by laminating the UV crosslinked adhesive coatings to a thickness of 1.0±0.2 mm. The DMA samples were ramped from 35° C. to-50° C. at a rate of 3° C./min, with a strain of 2 percent and a strain rate of 1 Hz. The T_{g} was taken as the temperature where the peak in tanδ occurred during the temperature ramp.

### Test Method 3: Peel Adhesion

A 1 cm width of the adhesive coated between two release liners was cut to approximately 15 cm in length. The first liner was peeled away, and the adhesive was laminated to a 51 μm (2 mil) thick plasma treated PET film from 3M Company (St. Paul, MN). Then the second release liner was removed, and the adhesive-PET construction was laminated to a plate of soda-lime float glass that had been cleaned by wiping with isopropyl alcohol and allowed to air dry for several minutes. A 2 kg (4.5 pound) rubber roller was rolled over the strip three times in each direction (total of six passes) to adhere it to the glass plate. The samples were allowed to dwell 24 hours at ° C. and 50 percent relative humidity (RH) prior to testing, which was conducted under the same environmental conditions (25° C. and 50 percent RH). To execute the peel test, the free end of the adhesive coated PET strip was doubled back so that the angle of removal from the glass plate was 180 degrees. The free end was attached to the stationary clamp arm of an IMASS SP-2100 peel tester from IMASS Inc. (Accord, MA). The glass plate was then affixed to the platform of the peel tester which is mechanized to move at a controlled rate away from the stationary clamp. The peel rate used was 6 cm/min. The peel force for each test was taken as the average over a 20 second peel duration, following a 4 second delay from the start of the peel motion. The reported values are averages of five replicate tests per sample.

### Test Method 4: Haze Measurement

Percent haze was measured with a HunterLab Ultrascan Pro spectrophotometer from Hunter Associates Laboratory, Inc. (Reston, VA). Measurements were made in transmission mode using the EasyMatch QC software. Samples were prepared by laminating a piece of UV crosslinked adhesive approximately 70×40 mm to a 50×75×0.7 mm Eagle XG LCD glass substrate from Corning (Corning, NY). The photosensor was calibrated following the manufacturer's standardization procedure prior to testing each sample set. A clean piece of LCD glass substrate without adhesive was run as a standard blank. The reported percent haze values are averages of two measurements taken on separate locations of each sample.

### Test Method 5: Dielectric Constant Measurement

The dielectric constant at 100 kHz was analyzed via dielectric spectroscopy. Samples were prepared by laminating the adhesive coatings to a thickness of 300 μm. The dielectric property measurements were performed with an Alpha-A High Temperature Broadband Dielectric Spectrometer modular measurement system from Novocontrol Technologies Gmbh (Montabaur, Germany). All testing was performed in accordance with the ASTM D150 test standard. Surfaces without adhesive were painted with copper or silver paint. Surfaces with adhesive are laminated directly on the brass electrode without any copper or silver paint. The decision to apply a conformal conductive electrode depends on how well the samples were able to conform to the electrode surface. The Novocontrol ZGS Alpha Active Sample Cell was implemented once each sample was placed between two optically polished brass disks (diameter 40.0 mm and thickness 2.00 mm). The reported values are averages of three replicates per sample.

### Test Method 6: Heat Aging Analysis

Approximately 500 milligrams of the uncrosslinked first (meth)acrylate polymer) or first (meth)acrylate polymer and second (meth)acrylate polymer blend were placed in a glass vial and heated at 170° C., under vacuum (approximately 100 Torr) for 30 minutes. After 30 minutes, the samples were removed from the oven and allowed to cool to room temperature. The molecular weight of these samples, which underwent heat aging, was analyzed following Test Method 1: Molecular weight analysis was done using GPC.

### Preparatory Examples: Preparation of High Molecular Weight First (Meth)Acrylate Polymer and Low Molecular Weight Second (Meth)Acrylate Polymer

The high molecular weight first (meth)acrylate polymer and low molecular weight second (meth)acrylate polymer were prepared according to the compositions in Table 2 and Table 3 using the following general procedure. The monomers (nBA, 2EHA, IBOA, HPA, Acm, and AEBP), solvent, initiator, and chain transfer agent were combined in a glass bottle. The monomer solutions were purged with nitrogen, and then the bottles were quickly capped. To perform the polymerizations, the bottles were then agitated in a 60° C. water bath for 24 hours. Following this polymerization step the high molecular weight first (meth)acrylate polymer solutions (P1-1 and P1-2) were subsequently used as is for preparation of the example materials. The low molecular weight second (meth)acrylate polymers (P2-1 through P2-9) underwent a second reaction step to react a portion of the HPA monomers with IEM, in order to incorporate pendant methacrylate functionality. The corresponding amounts of IEM shown in Table 3 were added to the bottles of polymer solution from the first polymerization step. The bottles were then re-capped and agitated in a 70° C. water bath for 24 hours. Following this second reaction step, the low molecular weight second (meth)acrylate polymer solutions (P2-1 through P2-9) were subsequently used for preparation of example materials. In Tables 2 and 3, “pph” means parts per hundred relative to the total mass of monomers (e.g., nBA, 2EHA, IBOA, HPA, and Acm) in each sample.

TABLE 2
Preparation of high molecular weight first (meth)acrylate polymer (P1-1 and P1-2)

| | | | | | | AEBP | VAZO 52 | TDDM | EtOAc | Mw |
|---|---|---|---|---|---|---|---|---|---|---|
| | nBA | 2EHA | IBOA | HPA | Acm | (pph) | (pph) | (pph) | (pph) | (kDa) |
| P1-1 | 40 | 40 | 0 | 15 | 5 | 0.2 | 0.1 | 0.09 | 100 | 400 |
| P1-2 | 42 | 42 | 11 | 0 | 5 | 0.2 | 0.1 | 0.09 | 100 | 370 |

TABLE 3
Preparation of low molecular weight second
(meth)acrylate polymer (P2-1 to P2-9)

| | | | VAZO 52 | IOTG | MEK | IEM | Mw |
|---|---|---|---|---|---|---|---|
| | 2EHA | HPA | (pph) | (pph) | (pph) | (pph) | (kDa) |
| P2-1 | 70 | 30 | 0.1 | 2.0 | 100 | 2.33 | 21 |
| P2-2 | 60 | 40 | 0.1 | 2.0 | 100 | 2.33 | 22 |
| P2-3 | 70 | 30 | 0.1 | 0.7 | 100 | 2.33 | 53 |
| P2-4 | 70 | 30 | 0.1 | 0.4 | 100 | 2.33 | 72 |
| P2-5 | 70 | 30 | 0.1 | 4.5 | 100 | 2.33 | 9 |
| P2-6 | 40 | 60 | 0.1 | 2.0 | 100 | 2.33 | 22 |
| P2-7 | 70 | 30 | 0.1 | 2.0 | 100 | 1.17 | 20 |
| P2-8 | 70 | 30 | 0.1 | 2.0 | 100 | 4.66 | 20 |
| P2-9 | 50 | 50 | 0.1 | 2.0 | 100 | 2.33 | 20 |

### Example (E1 to E10) and Comparative Example (CE1 to CE2) Preparation

The specified solutions of the high molecular weight first (meth)acrylate polymers (P1-1 and P1-2) and of the low molecular weight second (meth)acylate polymers (P2-1 to P2-9) were weighed into a glass jar. The specified second (meth)acrylate polymer percentage in Table 4A is based upon the total weight of the blend (first (meth)acrylate polymer plus second (meth)acrylate polymer). In addition, 0.4 pph (relative to the total weight of the first (meth)acrylate polymer and second (meth)acrylate polymer) of OMNIRAD TPO was added to each sample as a UV photoinitiator for radical crosslinking of the pendant methacrylate groups of the low molecular weight second (meth)acrylate polymer after coating. After addition of all the components, the jars were tightly capped and rolled on a jar roller with motorized rolling shafts at approximately 10 rotations per minute for at least 12 hours to achieve complete mixing of all the components prior to coating.

The sample solutions were coated via knife coater onto a 75 μm PET liner with a release coating (RF22N obtained from SKC Haas, Korea) and dried for 15 minutes at room temperature, followed by 30 minutes at 70° C. The dry thickness of all the sample coatings was 100 μm±10 μm. Following drying, a second liner (RF02N obtained from SKC Haas, Korea) was laminated on top of the sample coatings.

The sample coatings were cured by exposing them to UV radiation to form the crosslinked adhesive coatings. The sample coatings were irradiated through the second liner using a Fusion UV processor obtained from Fusion UV Systems, Inc. (Gaithersburg, MD), equipped with a D-bulb. The system settings (e.g., power, conveyer speed) were selected to provide a total UVA energy dosage of 3 J/cm², as calibrated using a Power Puck II UV radiometer from EIT (Leesburg, VA). The properties of the Examples and Comparative Examples are summarized in Table 4B.

TABLE 4A
Material in Examples and Comparative Examples

| | | | Second | |
|---|---|---|---|---|
| | | | (meth)acrylate | |
| | First | Second | polymer | Total OH- |
| | (meth)acrylate | (meth)acrylate | loading | monomer |
| Sample | polymer | polymer | (%) | (%) |
| CE1 | P1-1 | — | — | 15 |
| CE2 | P1-2 | — | — | 0 |
| E1 | P1-2 | P2-1 | 30 | 9 |
| E2 | P1-2 | P2-2 | 30 | 12 |
| E3 | P1-2 | P2-3 | 30 | 9 |
| E4 | P1-2 | P2-4 | 30 | 9 |
| E5 | P1-2 | P2-5 | 30 | 9 |
| E6 | P1-2 | P2-6 | 15 | 9 |
| E7 | P1-2 | P2-7 | 30 | 9 |
| E8 | P1-2 | P2-8 | 30 | 9 |
| E9 | P1-2 | P2-2 | 37.5 | 15 |
| E10 | P1-2 | P2-9 | 30 | 15 |

TABLE 4B
Properties of Examples and Comparative Examples

| | | | 180° peel from | |
|---|---|---|---|---|
| | T_{g} | | glass @ 25° C. | Dk |
| Sample | (° C.) | Haze % | (N/cm) | (@100 kHz) |
| CE1 | −10.8 | 0.42 | 5.85 | 4.60 |
| CE2 | −15.7 | 0.26 | 5.50 | 3.98 |
| E1 | −17.3 | 0.12 | 5.93 | 4.19 |
| E2 | −15.2 | 0.21 | 6.76 | 4.33 |
| E3 | −19.2 | 0.16 | 6.78 | — |
| E4 | −17.5 | 0.14 | 6.42 | — |
| E5 | −20.5 | 0.13 | 5.27 | — |
| E6 | −9.1 | 4.08 | 6.98 | 4.12 |
| E7 | −18.5 | 0.18 | 5.52 | — |
| E8 | −17.0 | 0.10 | 6.83 | — |
| E9 | −14.4 | 0.23 | 7.80 | 4.28 |
| E10 | −12.0 | 0.92 | 6.45 | 4.21 |

Table 5 shows the change in molecular weight for the two polymers (the first (meth)acrylate polymer and the second (meth)acrylate polymer) after high temperature exposure such as would occur during extrusion of the crosslinkable composition. P1 corresponds to the high molecular weight first (meth)acrylate polymer and P2 corresponds to the second (meth)acrylate polymer. The molecular weight values in Table 5 show a much lower overall change in molecular weight with high temperature exposure for HPA-free CE-2 compared to the Mz change for HPA-containing CE-1, which increased by 34 percent. Neither of these two comparative samples included the low molecular weight second (meth)acrylate polymer. Examples containing a second (meth)acrylate polymer had a smaller molecular weight increase upon aging compared to CE1. At high temperatures the hydroxyalkyl monomers can participate in transesterification reactions with the alkyl acrylate monomeric units of the first (meth)acrylate polymers, resulting in crosslinking.

TABLE 1
Molecular weight (Mz) change for Peak 1 (P1) and Peak 2 (P2)
after high temperature (170° C.) exposure under vacuum.

| | P1 | P1 | P1 | P2 | P2 | P2 |
|---|---|---|---|---|---|---|
| | initial | post heat | Mz | initial | post heat | Mz |
| Exam- | Mz | Mz | % | Mz | Mz | % |
| ple | (kDa) | (kDa) | change | (kDa) | (kDa) | change |
| CE1 | 880 | 1175 | 34 | — | — | — |
| CE2 | 732 | 773 | 5.6 | — | — | — |
| E1 | 628 | 641 | 2.1 | 24.1 | 24.2 | 0.4 |
| E2 | 621 | 653 | 5.2 | 25.6 | 25.0 | −2.3 |
| E5 | 622 | 651 | 4.7 | 12.2 | 12.3 | 0.8 |
| E6 | 588 | 615 | 4.6 | 22.1 | 20.9 | −5.4 |
| E9 | 556 | 559 | 0.5 | 26.5 | 26.0 | −1.9 |
| E10 | 539 | 562 | 4.3 | 25.3 | 24.0 | −5.1 |

1. A crosslinkable composition comprising:
a) 50 to 95 weight percent of a first (meth)acrylate polymer based on a total weight of polymeric material in the crosslinkable composition, the first (meth)acrylate polymer having a weight average molecule weight in a range of 100,000 Daltons to 1,500,000 Daltons, wherein the first (meth)acrylate polymer comprises
1) a monomeric unit derived from an alkyl (meth)acrylate;
2) an optional monomeric unit derived from a hydroxy-containing monomer in an amount ranging from 0 to 10 weight percent based on a total weight of monomeric units in the first (meth)acrylate polymer;
3) an optional crosslinking monomeric unit having a pendant (meth)acryloyl group or derived from a UV crosslinking monomer having an aromatic ketone group; and
b) 5 to 50 weight percent of a second (meth)acrylate polymer based on the total weight of polymeric material in the crosslinkable composition, the second (meth)acrylate polymer having a weight average molecular weight in a range of 5,000 Daltons to less than 100,000 Daltons, wherein the second (meth)acrylate polymer comprises
1) a monomeric unit derived from an alkyl (meth)acrylate; and
2) a monomeric unit derived from a hydroxy-containing monomer in an amount ranging from 30 to 70 weight percent based on a total weight of monomeric units in the second (meth)acrylate polymer; and
3) a crosslinking monomeric unit having a pendant (meth)acryloyl group in an amount ranging from 0.3 to 3 weight percent based on the total weight of monomeric units in the second (meth)acrylate polymer.

2. The crosslinkable composition of claim 1, wherein the first (meth)acrylate polymer has a weight average molecular weight in a range of 100,000 to 750,000 Daltons.

3. The crosslinkable composition of claim 1, wherein the second (meth)acrylate polymer has a weight average molecular weight in a range of 5,000 to 80,000 Daltons.

4. The crosslinkable composition of claim 1, wherein the first (meth)acrylate polymer further comprises optional monomeric units derived from a non-hydroxy-containing polar monomer.

5. The crosslinkable composition of claim 1, wherein the first (meth)acrylate polymer comprises 65 to 100 weight percent monomeric units derived from the alkyl (meth)acrylate, 0 to 10 weight percent monomeric units derived from the hydroxy-containing monomer, 0 to 30 weight percent monomeric units derived from a non-hydroxy-containing polar monomer, and 0 to 5 weight percent crosslinking monomeric units derived from a crosslinking monomer, wherein each amount is based on the total weight of monomeric units in the first (meth)acrylate polymer.

6. The crosslinkable composition of claim 1, wherein the first (meth)acrylate polymer comprises 0.1 to 5 weight percent crosslinking monomeric units based on the total weight of monomeric units in the first (meth)acrylate polymer.

7. The crosslinkable composition of claim 1, wherein second (meth)acrylate polymer further comprises optional monomeric units derived from a non-hydroxy-containing polar monomer.

8. The crosslinkable composition of claim 1, wherein the second (meth)acrylate polymer comprises 5 to 85 weight percent monomeric units derived from the alkyl (meth)acrylate, 30 to 70 weight percent monomeric units derived from the hydroxy-containing monomer, 0.3 to 3 weight percent monomeric units having the pendant (meth)acryloyl group, and 0 to 20 weight percent of a non-hydroxy-containing polar monomer.

9. The crosslinkable composition of claim 1, further comprising a photoinitiator.

10. A crosslinked composition comprising a reaction product of a crosslinkable composition of claim 1 exposed to ultraviolet radiation or ionizing radiation.

11. The crosslinked composition of claim 10, wherein the crosslinked composition is a pressure-sensitive adhesive or a heat bondable adhesive.

12. An article comprising:
a substrate; and
a layer of a crosslinkable composition of claim 1 positioned adjacent to the substrate.

13. An article comprising:
a substrate; and
a layer of a crosslinked composition of claim 10 positioned adjacent to the substrate.

14. The article of claim 13, wherein the substrate is a component of an electronic device.
